(19) United States
(12) Patent Application Publication
(10) Pub. No.: US 2006/0197627 A1
(43) Pub. Date: Sep. 7, 2006

(54) Low-loss directional bridge

(76) Inventor: Eric R. Ehlers, Santa Rosa, CA (US)

Correspondence Address: AGILENT TECHNOLOGIES, INC.;INTELLECTUAL PROPERTY ADMINISTRATION, LEGAL DEPT., M/S DU404, P.O. BOX 7599, LOVELAND, CO, 80537-0599, US

(21) Appl. No.: 11/233,170

(22) Filed: Sep. 21, 2005

Related U.S. Application Data
(63) Continuation-in-part of application No. 11/071,670, filed on Mar. 1, 2005.

(51) Int. Cl. H01P 5/18

(52) U.S. Cl. 333/112

(57) ABSTRACT

A low-loss directional bridge for measuring propagated signals from a source device to a load device or from a load device to a source device, where both the source device and the load device are in signal communication with the low-loss directional bridge. The low-loss directional bridge may include a first bridge circuit network and a first sensing element in signal communication with the first bridge circuit network. The first sensing element may produce a first measured signal that is proportional to the propagated signals. Additionally, the first bridge circuit network may include a first, a second, and a third impedance element in signal communication with the source device and the first sensing element.

### CROSS REFERENCE TO RELATED APPLICATION(S)

This application is a continuation-in-part of U.S. patent application Ser. No. 11/071,670 filed Mar. 1, 2005, titled “An Integrated Directional Bridge,” which is incorporated into this application in its entirety by reference.

### BACKGROUND OF THE INVENTION

Radio frequency (“RF”), microwave, and millimeter(“mm”)-wave applications of the present day and the future have a constant need for lower weight, volume, power consumption and cost together with greater functionality, frequency of operation and component integration. Examples of such applications include wireless handsets for messaging, wireless Internet services for e-commerce, and wireless data links such as Bluetooth.

Typically, telecommunication devices, and electronic equipment in general, include numerous types of electronic components and circuits including directional couplers and directional bridges. In general, directional couplers and directional bridges are electronic devices utilized in RF, microwave, and mm-wave signal routing for isolating, separating, or combining signals. Directional couplers and bridges also find use in a variety of measurement applications: power monitoring, source leveling, isolation of signal sources, and swept transmission and reflection measurements. Typically, directional couplers are utilized as impedance bridges for microwave and mm-wave measurements and for power monitoring.

Directional couplers and directional bridges (generally known as “directional circuits”) are usually three-port or four-port devices/circuits that have a signal input port (from a source) and a signal output port (to a load) and at least one coupled port whose output is proportional to either the incident wave (from the source) or the reflected wave (from the load). It is appreciated by those skilled in the art that it is common practice in RF, microwave, and mm-wave engineering to consider an electrical signal in an electronic circuit/device as the sum of an incident and a reflected traveling wave to and from, respectively, a load, or from and to, respectively, a source, relative to a characteristic impedance Z₀ of the electronic circuit/device (typically about 50 ohms). A directional circuit generally separates a transmitted signal into the detection circuit or coupled port based on the direction of the signal propagation. There are many uses for these directional circuits including network analysis and monitoring the output signal levels of a traveling wave incident on a load.

At present, there are numerous approaches to implementing a directional circuit. One example approach is to implement a distributed directional coupler as a device that has a physical length over which two transmission lines couple together electromagnetically or that utilizes the phase shift along a length of transmission line. In the distributed element model or transmission model of electronic circuits, it is assumed that each circuit element is finite, as opposed to infinitesimal, and the wires connecting elements are not perfect conductors, i.e., they have impedance. Another example approach (known as a directional bridge) may utilize lumped elements that may include transformers and resistors. In the lumped element model of electronic circuits, the simplifying assumption is made that each element is an infinitesimal point in space, and that the wires are perfect conductors. Thus, in this model the “lumped circuit elements” are the resistor, the capacitor, the inductor, and the transmission line, each of which may be lumped into a single point.

In FIG. 1, an example approach of an implementation of a known directional bridge circuit 100 is shown. The directional bridge circuit 100 may include three ports such as a signal input port (“port A 102”), a signal output port (“port B 104”), and at least one coupled port (“port C 106”). The directional bridge circuit 100 may be in signal communication with a signal source 108 via signal source impedance (“Z_{source}”) 110, and a load having a load impedance (“Z_{load}”) 112. As an example of operation, the directional bridge circuit 100 may be utilized to unequally split the signal 116 flowing in from the source at port A 102 while simultaneously fully passing the signal 114 flowing in from the opposite direction from the load 112 into port A. Ideally the signal 116 flowing in from the source at port A 102 will pass to the coupled port C 106 and appear as coupled signal 118. Similarly, an input signal 120 at port C 106 would be coupled fully to port A 102. However, port B 104 and port C 106 are isolated in that any signal 114 flowing into port B 104 will not appear at port C 106 but will propagate through to port A 102. Additionally, port B 104 is isolated from port C 106 because any signal 120 from port C 106 will flow to port A 102, and not to port B 104.

In FIG. 2, a block diagram of an example of an implementation of an integrated directional bridge circuit 200 utilizing a basic directional circuit topology is shown in normal configuration. The directional bridge circuit 200 may be in signal communication with a signal source 202 having a signal source impedance (“Z_{source}”) 204 and a load having a load impedance (“Z_{load}”) 206 via signal paths 208 and 210, respectively. The directional bridge circuit 200 may include impedance elements Z₁ 212, Z₂ 214, Z₃ 216, Z₄ 218, and Z₅ 220, and sensing element 222. In the example directional circuit topology, the signal source impedance Z_{source} 204 is in signal communication with both impedance elements Z₁ 212 and Z₄ 218. The load impedance Z_{load} 206 is in signal communication with both impedance elements Z₁ 212 and Z₂ 214. The sensing element 222 is in signal communication with both Z₄ 218 and Z₅ 220 at node 224 having a node voltage V₄. Similarly, the sensing element 222 is also in signal communication with both Z₂ 214 and Z₃ 216 at node 226 having a node voltage V₃. Both Z₅ 220 and Z₃ 216 are in signal communication with a common ground 228.

The impedance elements Z₁ 212, Z₂ 214, Z₃ 216, Z₄ 218, and Z₅ 220 may be either reactive impedance elements, real impedance elements (i.e., resistive elements), or combinations of real and reactive elements based on the frequency range of operation of the directional bridge circuit 200. The sensing element 222 (which may be a DC-coupled differential amplifier with a high common mode rejection ratio, or a Gilbert Cell mixer with differential RF input) senses the difference in voltage between node voltages V₃ and V₄ and produces a difference signal 230 of the voltage difference between node voltages V₃ and V₄ in both magnitude and phase, and characteristic impedance Z₀ of the directional coupling circuit 200 may be expressed as:

$${Z}_{0} = \frac{{Z}_{1} ( {Z}_{2} + {Z}_{3} )}{{Z}_{1} + {Z}_{2} - \frac{{Z}_{3} {Z}_{4}}{{Z}_{5}}} \qquad ( 2 )$$

As an example of operation, it is appreciated by those skilled in the art that the amplified difference signal 230 may be proportional to either the incident voltage signal (“V_{incident}”) 232 from the directional bridge circuit 200 to Z_{load} 206 or the reflected voltage (“V_{reflected}”) 234 from Z_{load} 206 to the directional bridge circuit 200. It is also appreciated that a passive load Z_{load} 206 produces V_{reflected} 234 by reflecting V_{incident} 232 and that the reference impedance Z₁ for V_{incident} 232 and V_{reflected} 234 is also given by equation (2). Additionally, it is appreciated that V_{reflected} 234 may be generated by Z_{load}, if Z_{load} is an active device.

If the sensing element 222 is a differential amplifier, such as an operational amplifier connected between the nodes 224 and 226, the proportional factor (“k”) is equal to the amplifier gain of the differential amplifier multiplied by the coupling factor of the directional bridge circuit 200. It is appreciated that based on the values of the impedance elements Z₁ 212, Z₂ 214, Z₃ 216, Z₄ 218, and Z₅ 220, the directional circuit 200 may be configured to produce an amplified difference signal 230 that is proportional to either V_{incident} 232 or V_{reflected} 234.

Unfortunately, directional couplers made using the distributed element model have the disadvantage that they are typically too large to be practical for an integrated circuit (“IC”) except at very high frequencies. And at low frequencies approaching direct current (“DC”), they also are typically too large to be practical for many electronic instruments. As an example, directional couplers are usually limited by size limitations to low frequency operation of about 10 megahertz (“MHz”) in most electronic devices.

Attempts to solve this problem include utilizing directional bridges because directional bridges typically operate at lower frequencies than directional couplers. However, while directional bridges may typically operate in the kilohertz (“KHz”) frequency range, they still unfortunately do not operate at low frequencies approaching DC. Additionally, similar to known directional couplers, known directional bridges are not suitable for integration on ICs because directional bridges generally utilize transformers that are difficult to implement with known IC technologies, particularly at low frequencies. Moreover, broadband instrument grade directional couplers and conventional directional bridges are typically implemented with expensive precision mechanical parts and assemblies and typically require hand assembly and adjustment.

Therefore, there is a need for a new directional circuit/device capable of operating continuously from DC up to high frequencies in the mm-wave range while being simple to integrate with known IC technologies.

### SUMMARY

A low-loss directional bridge circuit for measuring propagated signals from a source device to a load device and from the load device to the source device, where both the source device and the load device are in signal communication with the directional bridge circuit, is disclosed. The low-loss directional bridge circuit may include lumped elements in a conventional directional bridge circuit where impedances are replaced with impedances that are very large, thus approximating an open circuit, or very small, thus approximating a short circuit. The directional bridge circuit may also include resistive elements and reactive elements that result in a low-insertion-loss directional bridge circuit.

In an example of an implementation of the low-loss directional bridge in accordance with the invention, the first bridge circuit network may include a first impedance element in signal communication with both the source device and the first sensing element at a first node and a second impedance element in signal communication with the first impedance element at a second node and in signal communication with the first sensing element at a third node. Additionally, the first bridge circuit network may include a third impedance element in signal communication with both the second impedance element and the first sensing element at the third node. The first measured signal may be produced by the first sensing element in response to detecting a difference in voltage between a first voltage at the first node and a second voltage at the third node.

The low-loss directional bridge may further include a second bridge circuit network and a second sensing element in signal communication with the second bridge circuit network and both the first impedance element and the second impedance element at the second node, wherein the second sensing element produces a second measured signal that is proportional to the propagated signals. The second bridge circuit network may include a fourth impedance element in signal communication with both the first impedance element and the first sensing element at the first node and in signal communication with the second sensing element at a fourth node, and a fifth impedance element in signal communication with both the fourth impedance element and the second sensing element at the fourth node. The second measured signal may be produced by the second sensing element in response to detecting a difference in voltage between a third voltage at the fourth node and a fourth voltage at the second node.

Alternatively, the low-loss directional bridge may further include a second bridge circuit network and a second sensing element in signal communication with the second bridge circuit network and both a fourth impedance element and the load device at a fourth node, wherein the second sensing element produces a second measured signal that is proportional to the propagated signals. The second bridge circuit network may include a fifth impedance element in signal communication with both the first impedance element and the fourth impedance element at the second node and in signal communication with the second sensing element at a fifth node and a sixth impedance element in signal communication with both the fourth impedance element and the second sensing element at the fifth node. The second measured signal may be produced by the second sensing element in response to detecting a difference in voltage between the first voltage at the second node and a third voltage at the fourth node.

A low-loss directional bridge may be implemented in various configurations using lumped two-terminal elements, which may include resistors, capacitors, inductors, and transmission lines. As an example, a low-loss directional bridge network may be implemented having a low-pass configuration, in which case the first impedance element may include a series inductor, the second impedance element may include a shunt resistor, and the third impedance element may include a shunt capacitor. In the case of the low-pass configuration, the low-loss directional bridge may also include series matching capacitors.

Alternatively, the directional bridge may be implemented having a high-pass configuration, in which case the first impedance element may include a series capacitor, the second impedance element may include a shunt resistor, and the third impedance element may include a shunt inductor. In the case of the high-pass configuration, the low-loss directional bridge may also include series matching inductors. In yet another alternative, the directional bridge may be implemented having a bandpass configuration, in which case the first impedance element may include a series resonator, which may include a capacitor and an inductor in series, the second impedance element may include a shunt resistor, and the third impedance element may include a parallel resonator, which may include a capacitor and an inductor in parallel.

Additionally, a low-loss directional bridge may be implemented by cascading a plurality of directional bridge networks and forming a dual-directional bridge, which may have, by way of example, a low-pass low-pass configuration, a high-pass low-pass configuration, a low-pass high-pass configuration, or any other combination.

Additionally, the low-loss directional bridge may be implemented utilizing various devices as the sensing element. As an example, a low-loss directional bridge may be implemented using a detector diode or peak-to-peak detector diodes, as well as differential amplifiers.

Other systems, methods and features of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood with reference to the following figures. The components in the figures are not necessarily to scale, emphasis instead being placed upon illustrating the principles of the invention. In the figures, like reference numerals designate corresponding parts throughout the different views.

FIG. 1 shows a block diagram of an example of an implementation of a known directional bridge circuit.

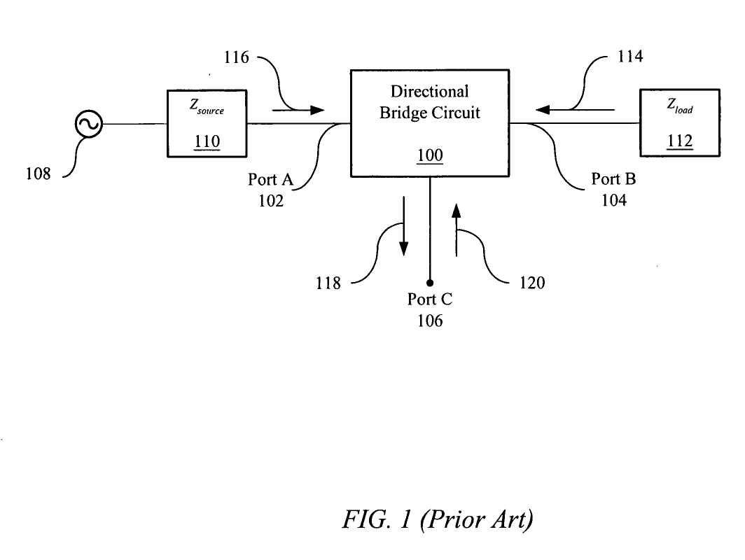

FIG. 2 shows a block diagram of an example of an implementation of a known directional bridge circuit in a normal configuration.

FIG. 3 shows a block diagram of an example of an implementation of an integrated low-loss directional bridge circuit utilizing a directional circuit topology in accordance with the invention.

FIG. 4 shows a block diagram of an example of an implementation of an integrated low-loss directional bridge circuit in a low-pass configuration in accordance with the invention.

FIG. 5 is a block diagram of an example of an implementation of an integrated low-loss directional bridge circuit in a high-pass configuration in accordance with the invention.

FIG. 6 shows a block diagram of an example of an implementation of an integrated low-loss directional bridge circuit in a bandpass configuration in accordance with the invention.

FIG. 7 shows a block diagram of an example of an implementation of an integrated low-loss directional bridge circuit in a low-pass configuration with series matching capacitors in accordance with the invention.

FIG. 8 shows a block diagram of another example of an implementation of an integrated low-loss directional bridge circuit in a high-pass configuration with series matching inductors in accordance with the invention.

FIG. 9 shows a block diagram of another example of an implementation of an integrated low-loss directional bridge circuit in a low-pass configuration with a parasitic series resistor in accordance with the invention.

FIG. 10 shows a block diagram of an example of an implementation of an integrated low-loss directional bridge utilizing a frequency-compensated directional bridge topology having a detector diode in accordance with the invention.

FIG. 11 shows a block diagram of an example of an implementation of an integrated low-loss directional bridge that utilizes a peak detector diode as a sensing element in accordance with the invention.

FIG. 12 shows a block diagram of yet another example of an implementation of an integrated low-loss directional bridge that utilizes a peak detector diode as a sensing element in accordance with the invention.

FIG. 13 shows a block diagram of an example of an implementation of an integrated low-loss directional bridge that utilizes peak-to-peak detector diodes as a sensing element in accordance with the invention.

FIG. 14 shows a block diagram of yet another example of an implementation of an integrated low-loss directional bridge that utilizes peak-to-peak detector diodes as a sensing element in accordance with the invention.

FIG. 15 shows a block diagram of yet another example of an implementation of an integrated low-loss directional bridge that utilizes peak-to-peak detector diodes as a sensing element in accordance with the invention.

FIG. 16 shows a block diagram of yet another example of an implementation of an integrated low-loss directional bridge that utilizes peak-to-peak detector diodes as a sensing element in accordance with the invention.

FIG. 17 shows a block diagram of an example of an implementation of an integrated low-loss directional bridge utilizing a dual-directional bridge topology with paralleled low-pass directional bridge circuits with each bridge circuit sharing a common series inductor in accordance with the invention.

FIG. 18 shows a block diagram of another example of an implementation of an integrated low-loss directional bridge utilizing a dual-directional bridge topology with cascaded high-pass and low-pass directional bridge circuits in accordance with the invention.

FIG. 19 shows a block diagram of an example of an implementation of an integrated low-loss detector directional bridge utilizing a pair of quarter wavelength transmission line resonators in accordance with the invention.

FIG. 20 shows a block diagram of another example of an implementation of an integrated low-loss directional bridge circuit in a low-pass configuration, having a coupling factor equal to −14 dB at a frequency of 1 GHz, in accordance with the invention.

FIG. 21 shows a block diagram of an example of an implementation of the integrated low-loss directional bridge circuit shown in FIG. 3, having resistor elements and a coupling factor equal to −14 dB, in accordance with the invention.

FIG. 22 shows a block diagram of a directional circuit having an ideal coupler with a coupling factor of −14 dB.

FIG. 23 shows a block diagram of an example implementation of an integrated low-loss directional bridge having cascaded high-pass and low-pass bridge circuits in accordance with the invention.

FIG. 24 shows a block diagram of an example of an implementation of an integrated low-loss directional bridge in a low-pass configuration having a diode peak detector without frequency compensation in accordance with the invention.

FIG. 25 shows a block diagram of an example of an implementation of an integrated low-loss directional bridge in a high-pass configuration having a diode peak detector without frequency compensation in accordance with the invention.

FIG. 26 shows a block diagram of an example of an implementation of an integrated low-loss directional bridge utilizing a directional bridge topology with cascaded high-pass and low-pass directional bridge circuits, with diode peak detectors and a detector output that is frequency compensated, in accordance with the invention.

FIG. 27 shows a graphical representation of a plot of detector output in decibels (“dB”) versus frequency in gigahertz (“GHz”) for the examples of implementations of integrated low-loss directional bridge circuits shown in FIGS. 24, 25, and 26.

FIG. 28 shows a graphical representation of a plot of insertion gain in dBs versus frequency in GHz for the examples of implementations of integrated low-loss directional bridge circuits shown in FIGS. 24, 25, and 26.

### DETAILED DESCRIPTION

In the following description of examples of embodiments, reference is made to the accompanying drawings that form a part hereof, and which show, by way of illustration, several specific embodiments in which the invention may be practiced. Other embodiments may be utilized and structural changes may be made without departing from the scope of the present invention.

In general, the invention is an integrated low-loss directional bridge that includes a plurality of lumped two-terminal elements connected in a directional bridge circuit with a sensing element that is configured to respond to a voltage difference between two nodes of the directional bridge circuit. It is appreciated by those skilled in the art that numerous types of directional circuit topologies may be utilized. Examples of the sensing element may include a passive transformer, a passive diode, a power sensing device, a direct current coupled (“DC-coupled”) differential amplifier with a high common mode rejection ratio, a differential amplifier that is not DC coupled, a Gilbert Cell mixer with differential radio frequency (“RF”) input, other mixers or samplers with differential RF inputs, or an integrated transformer or balun. For an integrated low-loss directional bridge circuit that operates at DC, the sensing element operates at DC and is DC-coupled. If phase information is not desired, a power or voltage magnitude sensing device such as a detector diode may be utilized as the sensing element.

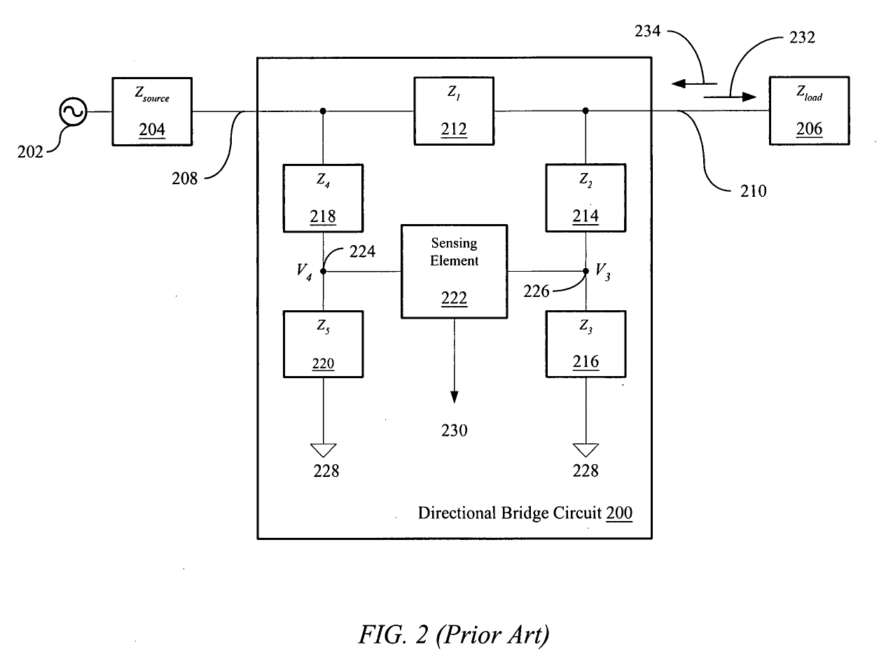

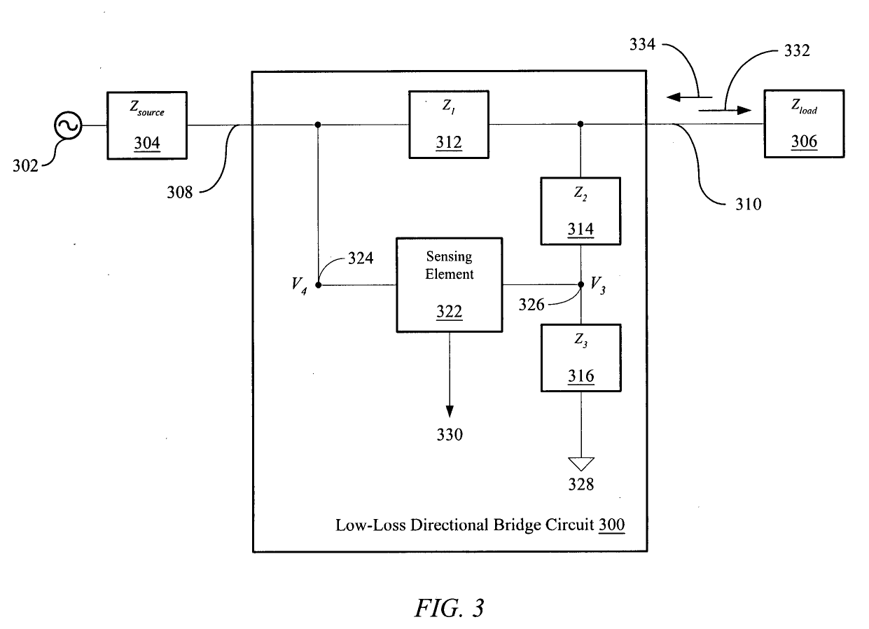

In FIG. 3, a block diagram of an example of an implementation of an integrated low-loss directional bridge circuit 300 utilizing a directional circuit topology is shown in accordance with the invention. In general, FIG. 3 is the integrated directional bridge circuit 200 of FIG. 2 with the impedances Z₄ 218 and Z₅ 220 of FIG. 2 being a very small impedance and a very large impedance, respectively. Thus Z₄ 218 approximates a short circuit (where Z₄ 218=0 and there is no voltage between nodes 208 and 224), and Z₅ 220 approximates an open circuit (where Z₅ 220=∞ and there is no current flow from node 224 to ground 228).

The low-loss directional bridge circuit 300 may be in signal communication with a signal source 302 having a signal source impedance (“Z_{source}”) 304 and a load having a load impedance (“Z_{load}”) 306 via signal paths 308 and 310, respectively. The low-loss directional bridge circuit 300 may include impedance elements Z₁ 312, Z₂ 314, and Z₃ 316, and sensing element 322. In this example directional bridge circuit topology, the signal source impedance Z_{source} 304 is in signal communication with impedance element Z₁ 312. The load impedance Z_{load} 306 is in signal communication with both impedance elements Z₁ 312 and Z₂ 314. The sensing element 322 is in signal communication with node 324 having a node voltage V₄. Similarly, the sensing element 322 is also in signal communication with both Z₂ 314 and Z₃ 316 at node 326 having a node voltage V₃. Z₃ 316 is in signal communication with a common ground 328.

The impedance elements Z₁ 312, Z₂ 314, and Z₃ 316 may be either reactive impedance elements, real impedance elements (i.e., resistive elements), or combinations of real and reactive elements based on the frequency range of operation of the low-loss directional bridge circuit 300. The sensing element 322 (which may be a DC-coupled differential amplifier with a high common mode rejection ratio, or a Gilbert Cell mixer with differential RF input) senses the difference in voltage between node voltages V₃ and V₄ and produces a difference signal 330 of the voltage difference between node voltages V₃ and V₄ in both magnitude and phase, and characteristic impedance Z₀ of the directional bridge circuit 300 may be expressed as:

$${Z}_{0} = \frac{{Z}_{1} ( {Z}_{2} + {Z}_{3} )}{{Z}_{1} + {Z}_{2}} \qquad ( 3 )$$

Z₀ is also the reference impedance of the incident and reflected waves 334 and 332.

As an example of operation, it is appreciated by those skilled in the art that the amplified difference signal 330 may be proportional to either the incident voltage signal (“V_{incident}”) 332 from the low-loss directional bridge circuit 300 to Z_{load} 306 or the reflected voltage (“V_{reflected}”) 334 from Z_{load} 306 to the low-loss directional bridge circuit 300, relative to Z₀ and independent of impedances Z_{source} 304, Z_{load} 306, and sensing element 322. It is also appreciated that a passive load Z_{load} 306 produces V_{reflected} 334 by reflecting V_{incident} 332. Additionally, it is appreciated that V_{reflected} 334 may be generated by Z_{load}, if Z_{load} is an active device.

If the sensing element 322 is a differential amplifier such as an operational amplifier connected between the nodes 324 and 326, the proportional factor (“k”) is equal to the amplifier gain of the differential amplifier multiplied by the coupling factor of the directional bridge. It is appreciated that based on the values of the impedance elements Z₁ 312, Z₂ 314, and Z₃ 316, the low-loss directional bridge circuit 300 may be configured to produce an amplified difference signal 330 that is proportional to either V_{incident} 332 or V_{reflected} 334.

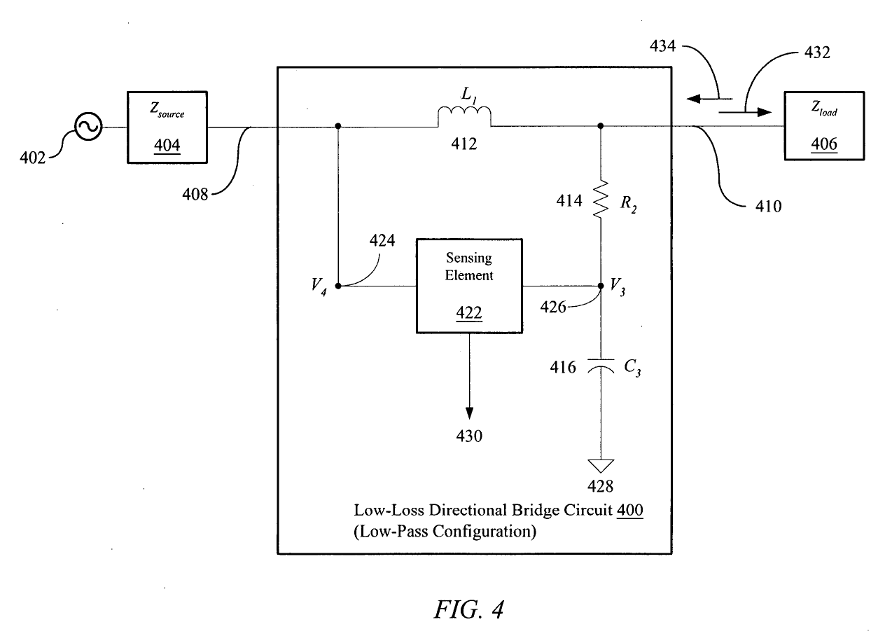

In FIG. 4, a block diagram of an example of an implementation of an integrated low-loss directional bridge circuit 400 utilizing a directional circuit topology in a low-pass configuration that includes a series inductor 412, a shunt resistor 414, and a shunt capacitor 416, is shown in accordance with the invention. The low-loss directional bridge circuit 400 may be in signal communication with a signal source 402 having a signal source impedance (“Z_{source}”) 404 and a load having a load impedance (“Z_{load}”) 406 via signal paths 408 and 410, respectively.

In this example, the sensing element 422 may be a differential amplifier and the low-loss directional bridge circuit 400 may be configured to produce the amplified difference signal 430 that is proportional to V_{incident} 432, the value of the amplified difference signal 430 may be approximately equal to kV_{incident}, and the characteristic impedance Z₀ of the low-loss directional bridge circuit 400 may be expressed as:

$${Z}_{0} = \frac{jω {L}_{1} {R}_{2} + \frac{{L}_{1}}{{C}_{3}}}{jω {L}_{1} + {R}_{2}} , \qquad ( 4 )$$

where Z₀ is independent of Z_{source} 404, Z_{load} 406, and the sensing element 422. It is appreciated by those skilled in the art that Zₒ may differ from an ideal desired Zₒ due to accidental (for example, process variations) or intentional changes in the impedance values of Z₁ through Z₃ and the low-loss directional bridge circuit 400 may still have satisfactory performance even if the difference signal 430 may not be exactly equal to kV_{incident}.

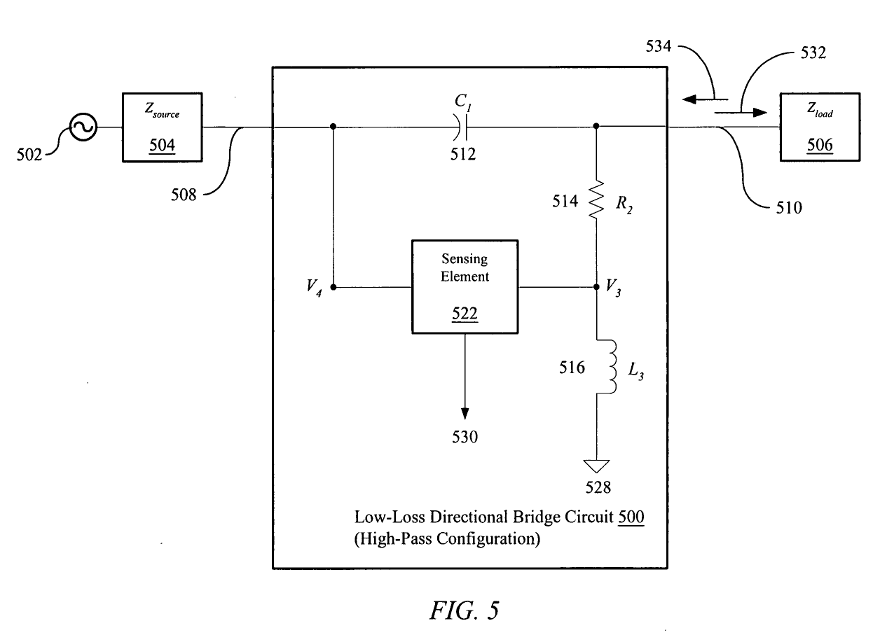

Similarly, in FIG. 5, a block diagram of an example of an implementation of a low-loss directional bridge circuit 500 utilizing a directional circuit topology in a high-pass configuration that includes a series capacitor 512, a shunt resistor 514, and a shunt inductor 516, is shown in accordance with the invention. The low-loss directional bridge circuit 500 may be in signal communication with a signal source 502 having a signal source impedance (“Z_{source}”) 504 and a load having a load impedance (“Z_{load}”) 506 via signal paths 508 and 510, respectively.

In this example, Z₀ of the low-loss directional bridge circuit 500 may be expressed as:

$${Z}_{0} = \frac{{R}_{2} + jω {L}_{3}}{1 + jω {C}_{1} {R}_{2}} , \qquad ( 5 )$$

where Z₀ is again independent of Z_{source} 504, Z_{load} 506, and the sensing element 522. Again, it is appreciated that Zₒ may differ from the ideal desired Zₒ due to accidental (for example, process variation) or intentional changes in the impedance values of Z₁ through Z₃ and the low-loss directional bridge circuit may still have satisfactory performance even if the difference signal 530 may not be exactly equal to kV_{reflected}.

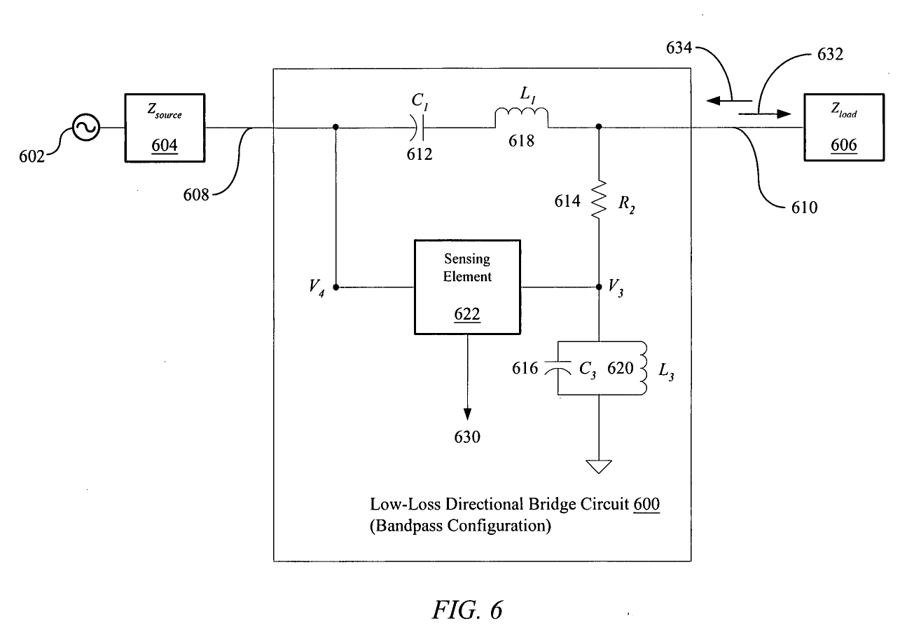

Similarly, in FIG. 6, a block diagram of an example of an implementation of a low-loss directional bridge circuit 600 utilizing a directional circuit topology in a bandpass configuration that includes a series resonator, a shunt resistor 614, and a parallel resonator, is shown in accordance with the invention. The low-loss directional bridge circuit 600 may be in signal communication with a signal source 602 having a signal source impedance (“Z_{source}”) 604 and a load having a load impedance (“Z_{load}”) 606 via signal paths 608 and 610, respectively.

In this example, the series resonator includes capacitor C₁ 612 and inductor L₁ 618, in series, and the parallel resonator includes capacitor C₃ 616 and inductor L₃ 620, in parallel, and Z₀ of the low-loss directional bridge circuit 600 may be expressed as:

$${Z}_{0} = \frac{j ( ω {L}_{1} - \frac{1}{ω {C}_{1}} ) ( {R}_{2} + \frac{1}{j ( ω {C}_{3} - \frac{1}{ω {L}_{3}} )} )}{j ( ω {L}_{1} - \frac{1}{ω {C}_{1}} ) + {R}_{2}} \qquad ( 6 )$$

where Z₀ is again independent of Z_{source} 604, Z_{load} 606, and the sensing element 622. Again, it is appreciated that Z₀ may differ from the ideal desired Z₀ due to accidental (for example, process variation) or intentional changes in the impedance values of Z₁ through Z₃ and the low-loss directional bridge circuit may still have satisfactory performance even if the difference signal 630 may not be exactly equal to kV_{reflected}.

Equations (4), (5), and (6) imply that Z₀ is a function of frequency and that a different set of values for L, R, and C must be chosen for each frequency. However, for element values chosen for low insertion loss, Z₀ is approximately independent of frequency. Equation (7) below defines the element values for the low-insertion-loss case of the low-pass configuration of FIG. 4, equation (8) below defines the element values for the low-insertion-loss case of the high-pass configuration of FIG. 5, and equation (9) below defines the element values for the low-insertion-loss case of the bandpass configuration of FIG. 6 when the frequency of operation is near resonance:

$$\begin{matrix}{Z}_{0} \approx \frac{{L}_{1}}{{R}_{2} {C}_{3}} when ω {L}_{1} {R}_{2} is small compared to {L}_{1} / {C}_{3} and ω {L}_{1} is small compared to {R}_{2} . & ( 7 ) \\ {Z}_{0} \approx \frac{{L}_{3}}{{R}_{2} {C}_{1}} when ω {L}_{3} is large compared to {R}_{2} and ω {C}_{1} {R}_{2} is large compared to 1. & ( 8 ) \\ {Z}_{0} \approx \frac{{L}_{1}}{{R}_{2} {C}_{3}} = \frac{{L}_{3}}{{R}_{2} {C}_{1}} where {ω}_{0}^{2} = \frac{1}{{L}_{1} {C}_{1}} = \frac{1}{{L}_{3} {C}_{3}} . & ( 9 )\end{matrix}$$

The properties of the directional bridge circuit that make the difference signal 330, FIG. 3, proportional to V_{incident} 332 or V_{reflected} 334, FIG. 3, are not affected by the impedance (“Z_{D}”) of the sensing element 322, FIG. 3, but the coupling factor and through-line insertion loss are dependent on Z_{D}. The coupling factor is the ratio of the voltage difference between node voltages V₃ and V₄ to the voltage V_{incident} on the load. The through-line gain is the ratio of the voltage V_{incident} on the load to the voltage V_{incident} on the source, both voltages relative to Z₀. Simple expressions for the coupling factor and through-line insertions loss can be derived where Z_{D} is large enough to be ignored. Examples of detector elements with high impedance are high input impedance differential amplifiers, diode peak detectors, and biased diode detectors with video resistances in the K ohm range.

Equation 10 (coupling factor) and equation 11 (through-line gain) below are valid for the schematic shown in FIG. 3 when Z_{D} is large enough to ignore in the calculations. Additionally, if Z₂ is made equal to Z₀, the coupled signal is either +90 degrees or −90 degrees out of phase with V_{incident} 332 or V_{reflected} 334, FIG. 3.

$$\begin{matrix}Coupling\_factor = \frac{{Z}_{1} + {Z}_{2}}{{Z}_{2} + {Z}_{3}} + \frac{{Z}_{1}}{{Z}_{0}} & ( 10 ) \\ Through\_line \_gain = \frac{1}{1 + \frac{{Z}_{1}}{2 {Z}_{0}} + \frac{{Z}_{1} + {Z}_{0}}{2 ( {Z}_{2} + {Z}_{3} )}} . & ( 11 )\end{matrix}$$

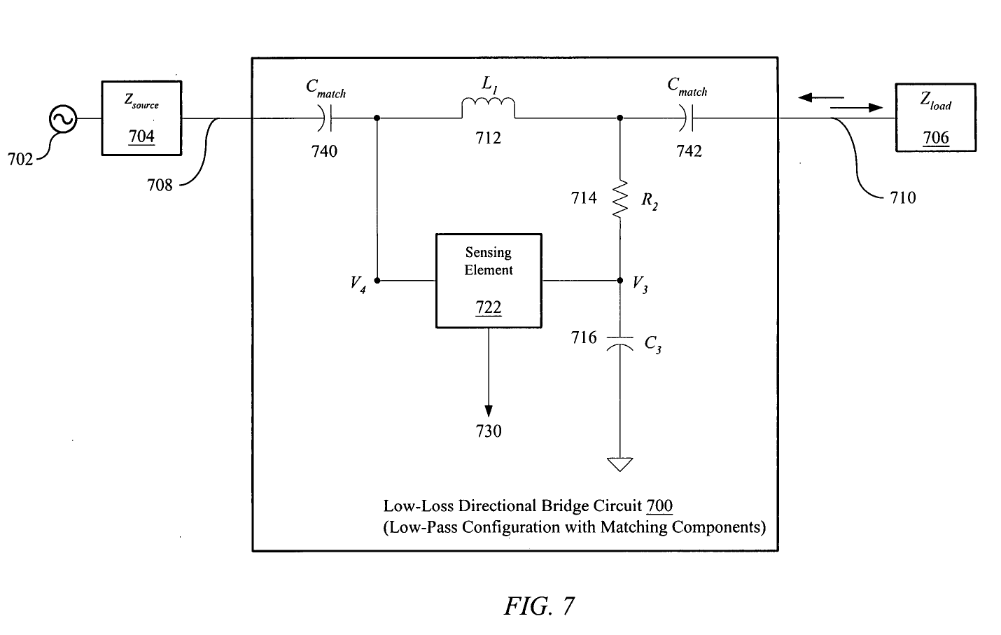

The insertion loss of a directional bridge circuit may be decreased by adding matching components at the source port or the load port (or both). As long as these matching components are small, the operation of the directional bridge circuits will remain satisfactory for most applications while retaining the advantage of lower insertion loss. In FIG. 7, a block diagram of an example of an implementation of an integrated low-loss directional bridge circuit 700 utilizing a directional circuit topology in a low-pass configuration that further includes series matching capacitors C_{match} 740 and 742, is shown in accordance with the invention. The low-loss directional bridge circuit 700 may be in signal communication with a signal source 702 having a signal source impedance (“Z_{source}”) 704 and a load having a load impedance (“Z_{load}”) 706 via signal paths 708 and 710, respectively.

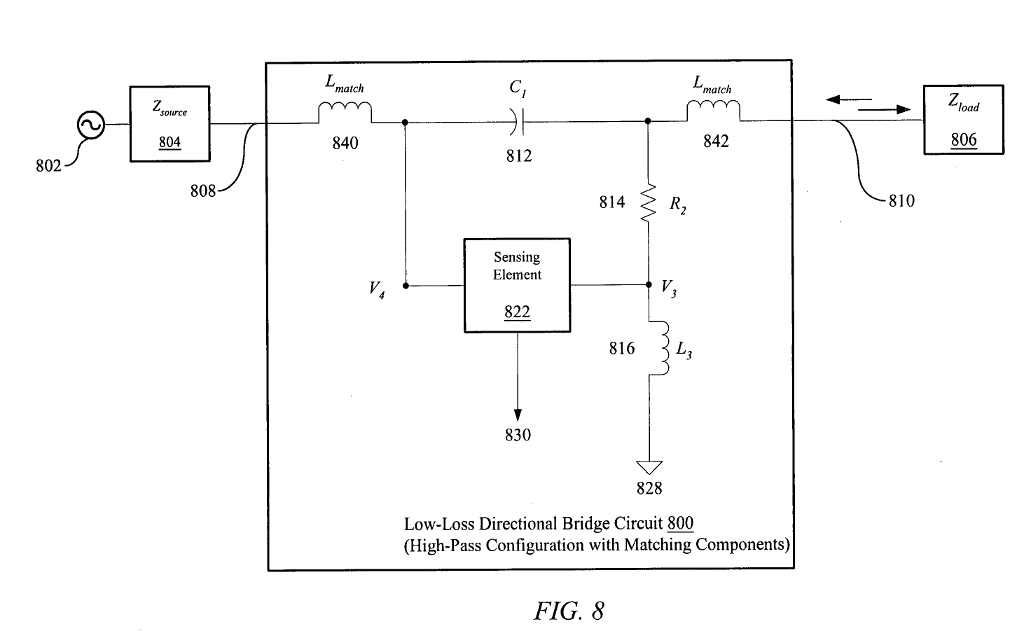

FIG. 8 shows a block diagram of an example of an implementation of an integrated low-loss directional bridge circuit 800 utilizing a directional coupling topology in a high-pass configuration that further includes series matching inductors L_{match} 840 and 842, in accordance with the invention. The low-loss directional bridge circuit 800 may be in signal communication with a signal source 802 having a signal source impedance (“Z_{source}”) 804 and a load having a load impedance (“Z_{load}”) 806 via signal paths 808 and 810, respectively.

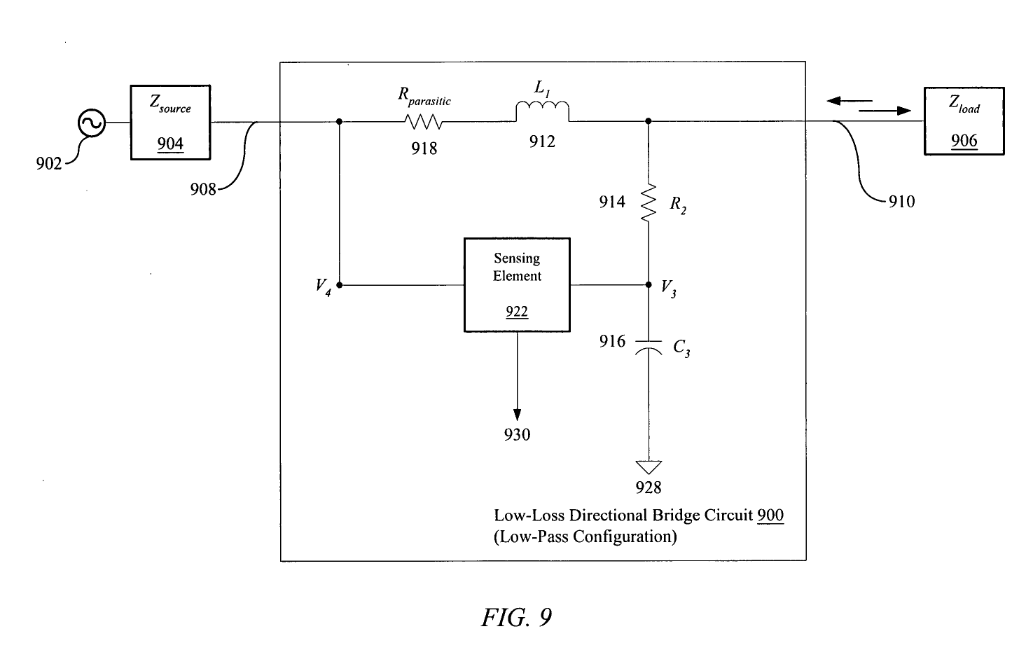

In an integrated circuit (“IC”) process, inductors may be fabricated as spiral inductors made of metal and having a physical length. As such, there is always a parasitic series resistance associated with the inductors that may be compensated for by certain implementations of the invention. FIG. 9 shows a block diagram of an example of an implementation of an integrated low-loss directional bridge circuit 900 utilizing a directional circuit topology in a low-pass configuration that includes a parasitic series resistor R_{parasitic} 918. The low-loss directional bridge circuit 900 may be in signal communication with a signal source 902 having a signal source impedance (“Z_{source}”) 904 and a load having a load impedance (“Z_{load}”) 906 via signal paths 908 and 910, respectively.

Z₀ of the low-loss directional coupling circuit 900 may be expressed as:

$${Z}_{0} = \frac{{R}_{parasitic} {R}_{2} + \frac{{R}_{parasitic}}{jω {L}_{1}} + jω {R}_{2} {L}_{1} + \frac{{L}_{1}}{{C}_{3}}}{{R}_{parasitic} + {R}_{2} + jω {L}_{1}} . \qquad ( 12 )$$

If R_{parasitic} 918 is small compared to a), (and making the low insertion loss approximation shown in Equation 3), ωL₁R₂ is small compared to ωL₁/C₃, and ωL₁ is small compared to R₂, Z₀ of the low-loss directional coupling circuit 900 may be expressed as:

$${Z}_{0} = {R}_{parasitic} + \frac{{L}_{1}}{{R}_{2} {C}_{3}} . \qquad ( 13 )$$

Characteristic impedance Z₀ and the element values in Equations (4), (5) and (6) are independent of frequency. This means that the coupled output signal (i.e., difference signal 330, FIG. 3) from the low-loss directional bridge circuit is proportional to the wave incident on the load at all frequencies. The coupling factor, however, may vary with frequency. In the low-pass configuration of FIG. 4, the coupling factor increases as the frequency increases, and in the high-pass configuration of FIG. 5, the coupling factor decreases as the frequency increases. This coupling factor increase or decrease with an increase in frequency may be compensated for by designing the Sensing Element 322, FIG. 3, with a sloped frequency response.

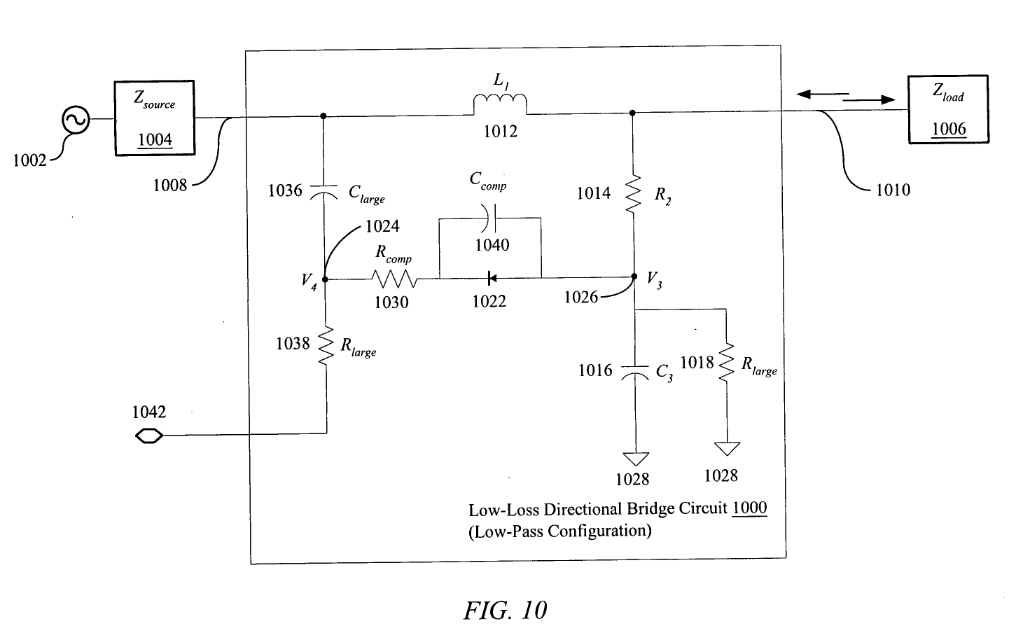

In FIG. 10, a block diagram of an example of an implementation of an integrated low-loss directional bridge circuit 1000 utilizing a directional circuit topology in a low-pass configuration that includes frequency compensation using a detector diode 1022, is shown in accordance with the invention. The low-loss directional bridge circuit 1000 may be in signal communication with a signal source 1002 having a signal source impedance (“Z_{source}”) 1004 and a load having a load impedance (“Z_{load}”) 1006 via signal paths 1008 and 1010, respectively. In FIG. 10, a low-pass filter is added to the Sensing Element of the low-loss directional bridge circuit 1000, which in this case is a detector diode 1022, yielding a flat overall coupling response over the desired frequency band.

The low-pass filter may include resister R_{comp} 1030 and capacitor C_{comp} 1040. Port 1042 may be a negative detector output. At the frequency of operation, C_{large} 1036 may be large enough so that it has a low impedance and the AC voltage between node 1024 and signal path 1008 is negligible. R_{large} 1038 may also be large enough so that there is negligible current flowing from node 1024 to port 1042 and the insertion loss from signal path 1008 to signal path 1010 is not increased. R_{large} 1018 may also be large enough so that its impedance is high compared to the impedance of capacitor C₃ 1016 at the frequency of operation.

In the case of the bandpass configuration shown in FIG. 6, the coupling factor decreases as the frequency increases below resonance and increases as the frequency increases above resonance where resonance refers to the resonant frequency of the series resonator (C₁ and L₁) and the parallel resonator (C₃ and L₃). Near resonance, the slope of the coupling response with frequency approaches zero and the coupling response goes to zero at resonance (assuming lossless resonators). The bandpass directional bridge circuit requires operation below or above resonance unless the resistive components of the resonators at resonance satisfy the required impedance relationship of Equations (2) or (3).

In general, the low-loss directional bridge circuits in the low-pass configurations shown in FIGS. 4 and 7 include the series inductors L₁ 412 and 712, the shunt elements R₂ 414 and 714 and C₃ 416 and 716, and the Sensing Elements 422 and 722, respectively. The low-loss directional bridge circuits in a high-pass configuration shown in FIGS. 5 and 8 include the series capacitor C₁ 512 and 812, the shunt elements R₂ 514 and 814 and L₃ 516 and 816, and the Sensing Elements 522 and 822, respectively. And the low-loss directional bridge circuit in a bandpass configuration shown in FIG. 6 includes the series resonator, which includes capacitor C₁ 612 and inductor L₁ 618, the shunt elements R₂ 614 and the parallel resonator, which includes capacitor C₃ 616 and inductor L₃ 620, and the Sensing Element 622. The Sensing Elements may be implemented in various ways and each Sensing Element may also include associated circuitry for bias and output connections, temperature compensation, etc. As an example implementation, the Sensing Element may be a low-barrier square-law detector diode, a peak detector diode, a differential amplifier, a mixer or a sampler or other component that responds to the difference in voltage between nodes V₄ and V₃.

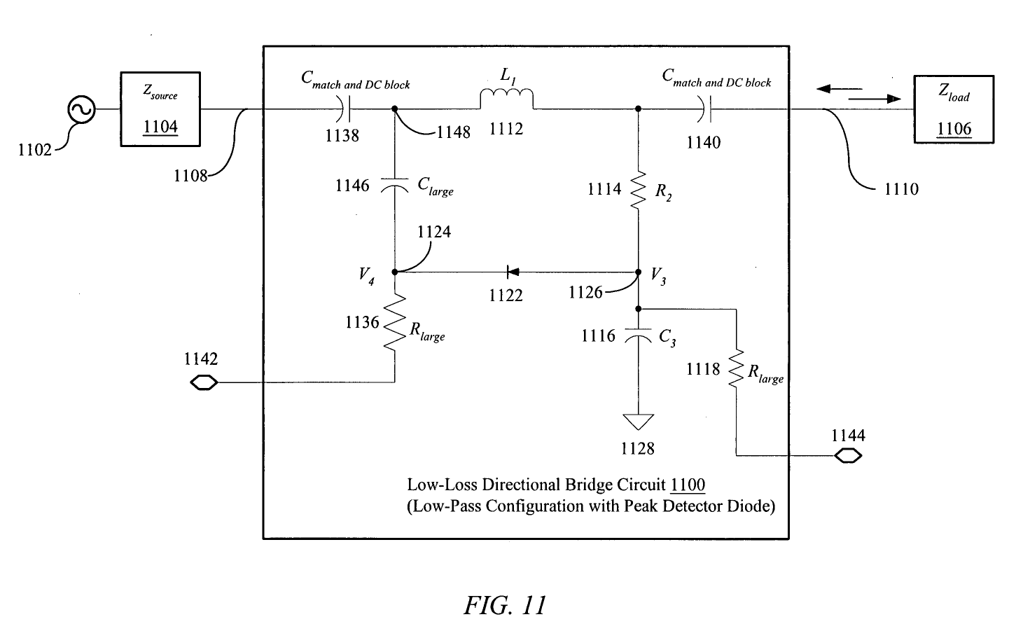

FIGS. 11 through 18 show block diagrams of low-loss directional bridge circuits with various Sensing Elements. FIG. 11 shows a block diagram of an example of an implementation of a low-loss directional bridge circuit 1100 in a low-pass configuration where the Sensing Element is a peak detector diode 1122. The low-loss directional bridge circuit 1100 may be in signal communication with a signal source 1102 having a signal source impedance (“Z_{source}”) 1104 and a load having a load impedance (“Z_{load}”) 1106 via signal paths 1108 and 1110, respectively. C_{match and DC block} 1138 and 1140 are matching capacitor elements and they may also function as DC blocks that are useful for preventing a DC voltage at signal paths 1108 or 1110, respectively, from appearing at the detector output ports 1142 and 1144. Port 1142 may be the positive detector output or the ground return for the negative detector output and port 1144 may be the negative detector output or the ground return for the positive detector output. At the frequency of operation, C_{large} 1146 may be large enough so that it has a low impedance and the AC voltage between node 1124 and node 1148 is negligible. R_{large} 1136 may also be large enough so that there is negligible current flowing from node 1124 to node 1142 and the insertion loss from signal path 1108 to signal path 1110 is not increased R_{large} 1118 may also be large enough so that its impedance is high compared to the impedance of capacitor C₃ 1116 at the frequency of operation.

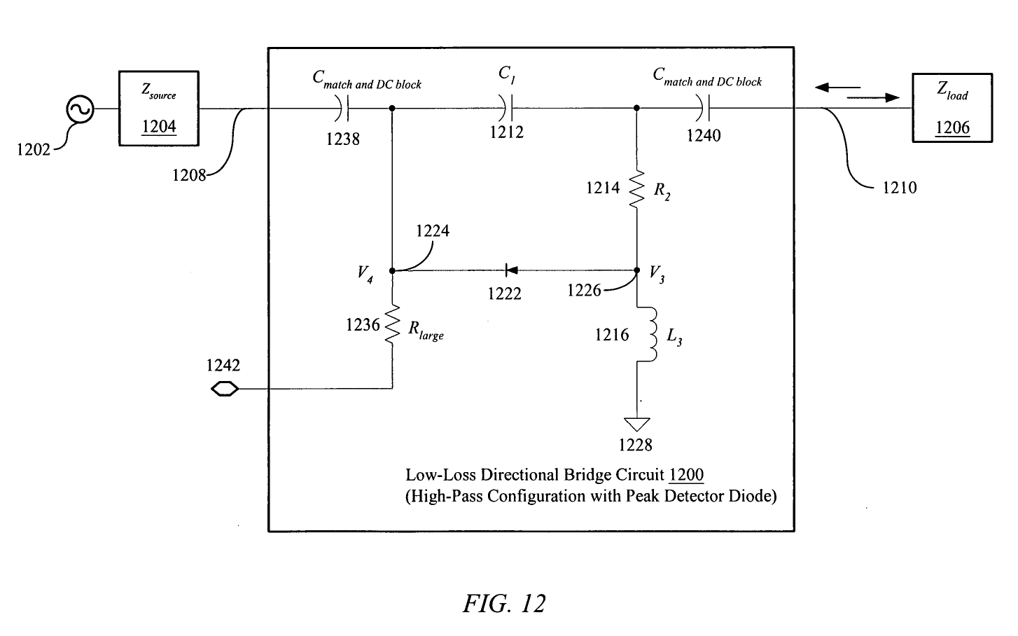

FIG. 12 shows a block diagram of another example of an implementation of a low-loss directional bridge circuit 1200 in a high-pass configuration where the Sensing Element is a peak detector diode 1222. The low-loss directional bridge circuit 1200 may be in signal communication with a signal source 1202 having a signal source impedance (“Z_{source}”) 1204 and a load having a load impedance (“Z_{load}”) 1206 via signal paths 1208 and 1210, respectively. C_{match and DC block} 1238 and 1240 are matching capacitor elements and they may also function as DC blocks that are useful for preventing a DC voltage at signal paths 1208 or 1210, respectively, from appearing at the detector output port 1242. Port 1242 may be a positive detector output. R_{large} 1236 may also be large enough so that there is negligible current flowing from node 1224 to port 1242 and the insertion loss from signal path 1208 to signal path 1210 is not increased.

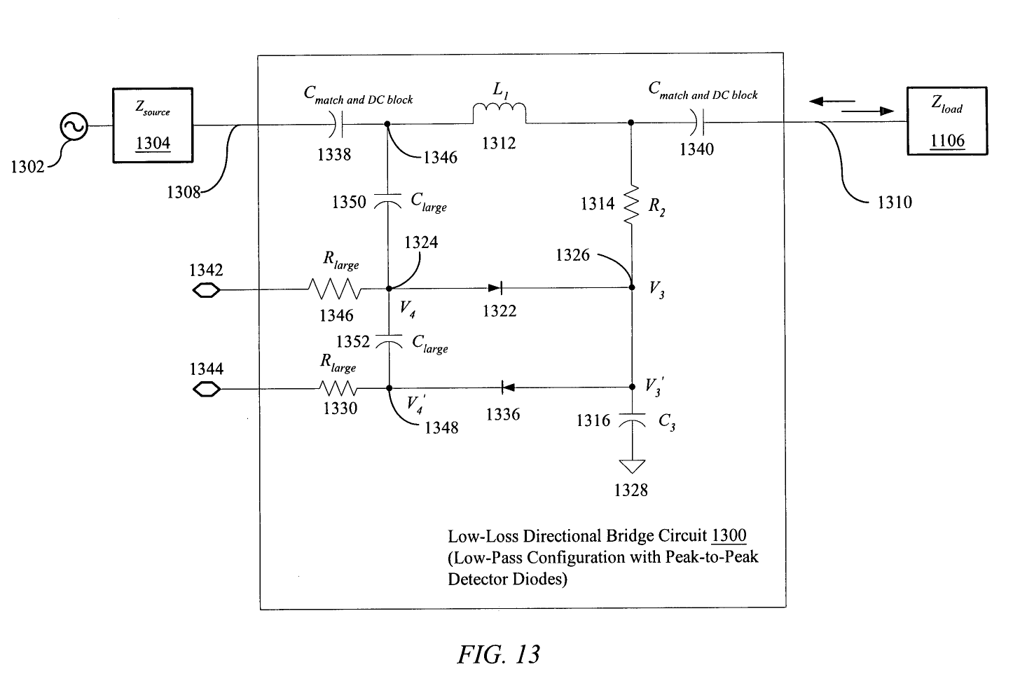

In FIG. 13, a block diagram of another example of an implementation of a low-loss directional bridge circuit 1300 in a low-pass configuration where the Sensing Element is a peak-to-peak detector having two detector diodes 1322 and 1336. The low-loss directional bridge circuit 1300 may be in signal communication with a signal source 1302 having a signal source impedance (“Z_{source}”) 1304 and a load having a load impedance (“Z_{load}”) 1306 via signal paths 1308 and 1310, respectively. C_{match and DC block} 1338 and 1340 are matching capacitor elements and they may also function as DC blocks that are useful for preventing a DC voltage at signal paths 1308 or 1310, respectively, from appearing at the detector output ports 1342 and 1344. Port 1342 may be a negative detector output or a ground return for a positive detector output, and port 1344 may be a positive detector output or a ground return for a negative detector output. At the frequency of operation, C_{large} 1350 may be large enough so that it has a low impedance and the AC voltage between node 1324 and node 1346 is negligible. At the frequency of operation, C_{large} 1352 may be large enough so that it has a low impedance and the AC voltage between node 1348 and node 1324 is negligible. R_{large} 1346 may be large enough so that there is negligible current flowing from node 1324 to port 1342 and the insertion loss from signal path 1308 to signal path 1310 is not increased. R_{large} 1330 may also be large enough so that there is negligible current flowing from node 1348 to port 1344 and the insertion loss from signal path 1308 to signal path 1310 is not increased.

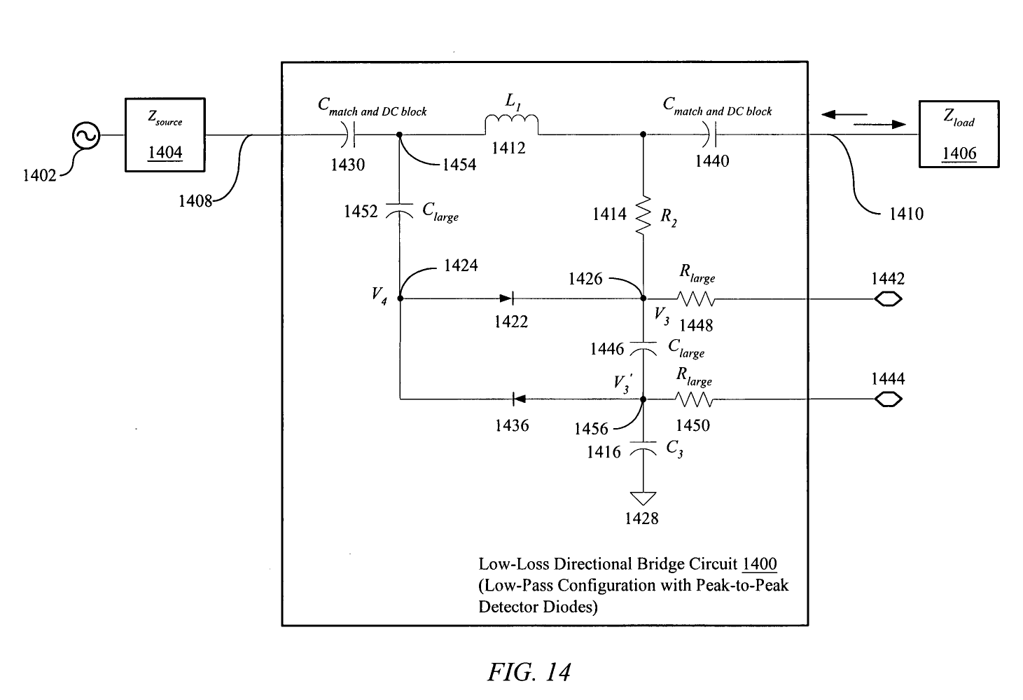

In FIG. 14, a block diagram of yet another example of an implementation of a low-loss directional bridge circuit 1400 in a low-pass configuration where the Sensing Element is a peak-to-peak detector having two detector diodes 1422 and 1436. The low-loss directional bridge circuit 1400 may be in signal communication with a signal source 1402 having a signal source impedance (“Z_{source}”) 1404 and a load having a load impedance (“Z_{load}”) 1406 via signal paths 1408 and 1410, respectively. C_{match and DC block} 1438 and 1440 are matching capacitor elements and they may also function as DC blocks that are useful for preventing a DC voltage at signal paths 1408 or 1410, respectively, from appearing at the detector output ports 1442 and 1444. Port 1442 may be a positive detector output or a ground return for a negative detector output, and port 1444 may be a negative detector output or a ground return for a positive detector output. At the frequency of operation, C_{large} 1452 may be large enough so that it has a low impedance and the AC voltage between node 1424 and node 1454 is negligible. At the frequency of operation, C_{large} 1446 may be large enough so that it has a low impedance and the AC voltage between node 1456 and node 1426 is negligible. R_{large} 1448 may be large enough so that there is negligible current flowing from node 1426 to port 1442 and the insertion loss from signal path 1408 to signal path 1410 is not increased. R_{large} 1450 may also be large enough so that there is negligible current flowing from node 1456 to port 1444 and the insertion loss from signal path 1408 to signal path 1410 is not increased.

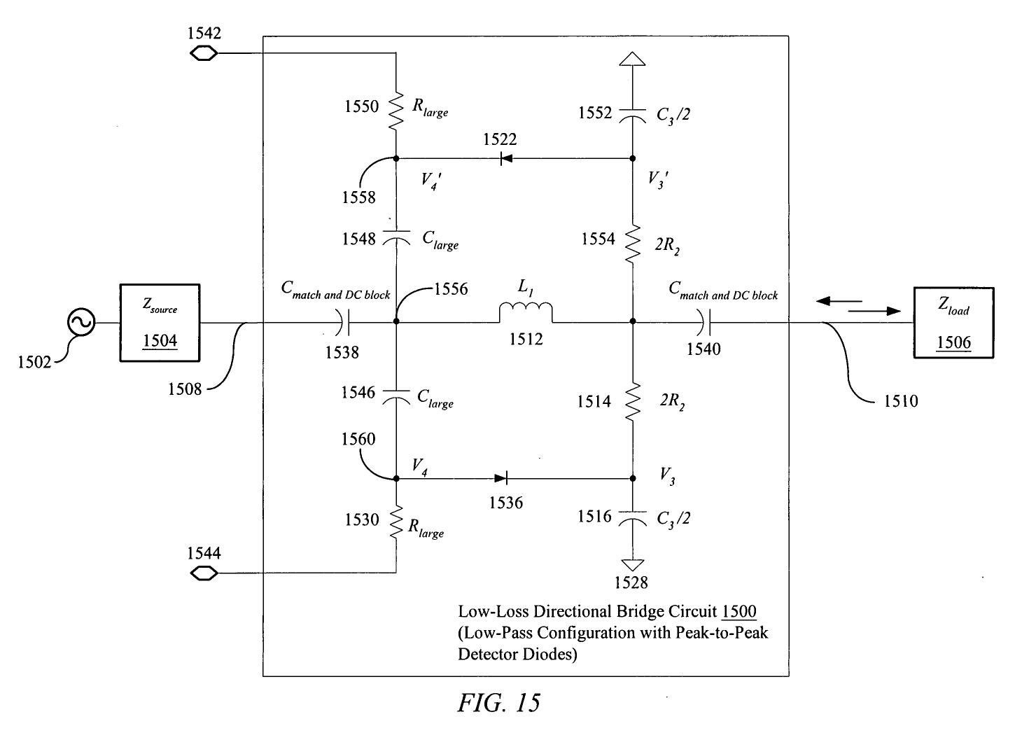

In FIG. 15, a block diagram of yet another example of an implementation of a low-loss directional bridge circuit 1500 in a low-pass configuration where the Sensing Element is a peak-to-peak detector having two detector diodes 1522 and 1536. The low-loss directional bridge circuit 1500 may be in signal communication with a signal source 1502 having a signal source impedance (“Z_{source}”) 1504 and a load having a load impedance (“Z_{load}”) 1506 via signal paths 1508 and 1510, respectively. C_{match and DC block} 1538 and 1540 are matching capacitor elements and they may also function as DC blocks that are useful for preventing a DC voltage at signal paths 1508 or 1510 from appearing at the detector output ports 1542 and 1544. Port 1542 may be a positive detector output or a ground return for a negative detector output, and port 1544 may be a negative detector output or a ground return for a positive detector output. At the frequency of operation, C_{large} 1548 may be large enough so that it has a low impedance and the AC voltage between node 1556 and node 1558 is negligible. At the frequency of operation, C_{large} 1546 may be large enough so that it has a low impedance and the AC voltage between V₄ node 1560 and node 1556 is negligible. R_{large} 1550 may be large enough so that there is negligible current flowing from node 1558 to port 1542 and the insertion loss from signal path 1508 to signal path 1510 is not increased. R_{large} 1530 may also be large enough so that there is negligible current flowing from node 1560 to port 1544 and the insertion loss from signal path 1508 to signal path 1510 is not increased.

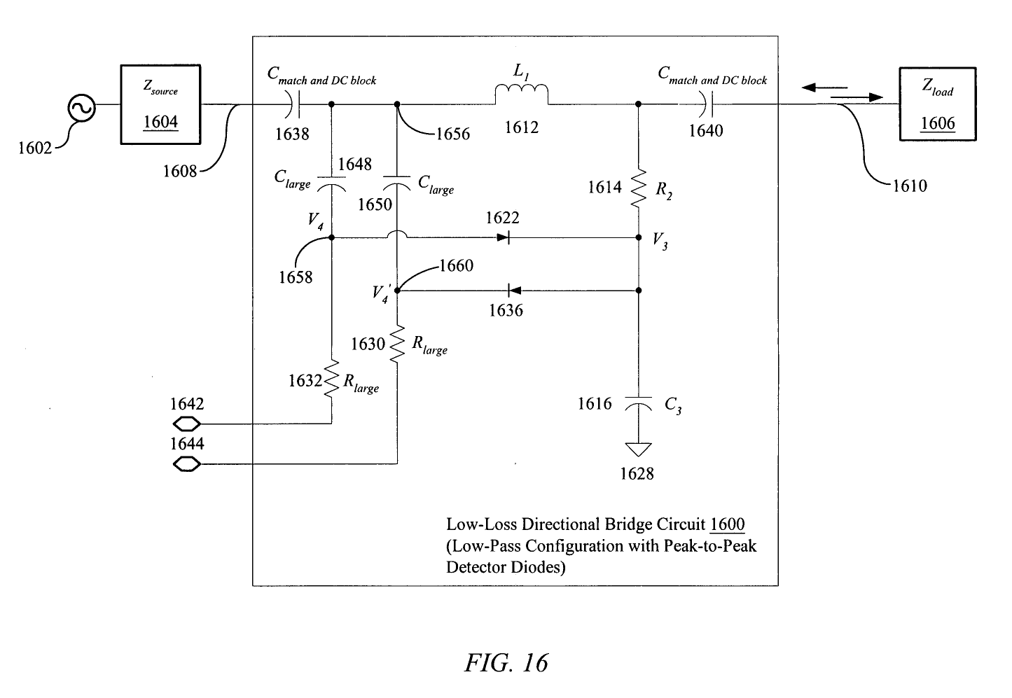

In FIG. 16, a block diagram of another example of an implementation of a low-loss directional bridge circuit 1600 in a low-pass configuration where the Sensing Element is a peak-to-peak detector having two detector diodes 1622 and 1636. The low-loss directional bridge circuit 1600 may be in signal communication with a signal source 1602 having a signal source impedance (“Z_{source}”) 1604 and a load having a load impedance (“Z_{load}”) 1606 via signal paths 1608 and 1610, respectively. C_{match and DC block} 1638 and 1640 are matching capacitor elements and they may also function as DC blocks that are useful for preventing a DC voltage at signal paths 1608 or 1610, respectively, from appearing at the detector output ports 1642 and 1644. Port 1642 may be a negative detector output or a ground return for a positive detector output, and port 1644 may be a positive detector output or a ground return for a negative detector output. At the frequency of operation, C_{large} 1648 may be large enough so that it has a low impedance and the AC voltage between node 1658 and node 1656 is negligible. At the frequency of operation, C_{large} 1650 may be large enough so that it has a low impedance and the AC voltage between node 1660 and node 1656 is negligible. R_{large} 1632 may be large enough so that there is negligible current flowing from node 1658 to port 1642 and the insertion loss from signal path 1608 to signal path 1610 is not increased. R_{large} 1630 may also be large enough so that there is negligible current flowing from node 1660 to port 1644 and the insertion loss from signal path 1608 to signal path 1610 is not increased.

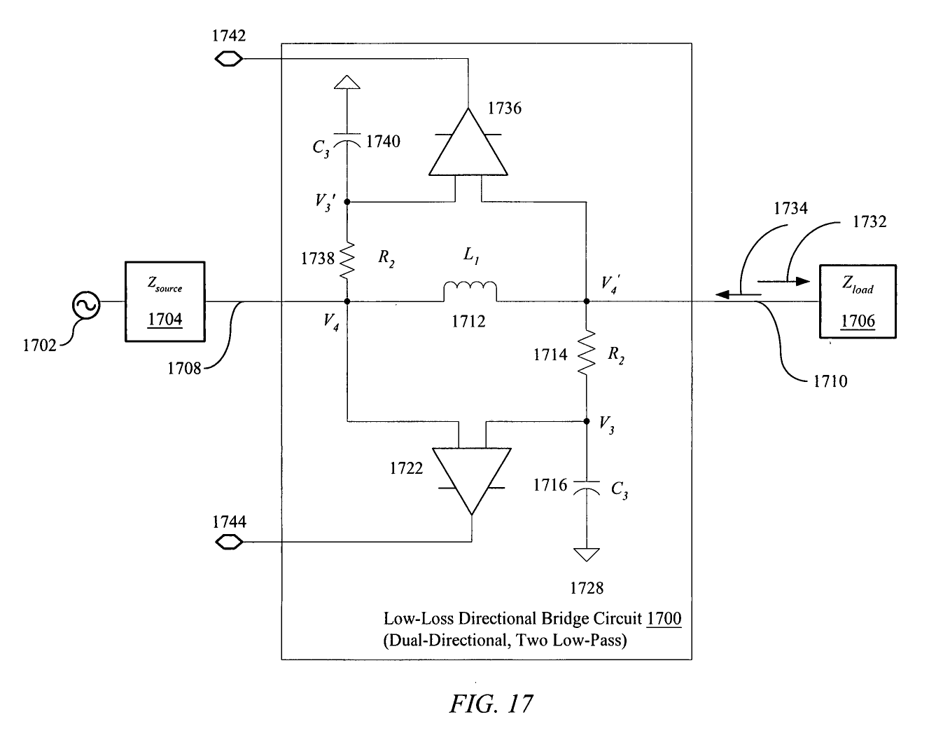

FIG. 17 shows a block diagram of an example of an implementation of a low-loss directional bridge circuit 1700 utilizing a parallel dual-directional bridge topology with two differential amplifiers 1722 and 1736 in accordance with the invention. The low-loss directional bridge circuit 1700 may be in signal communication with a signal source 1702 having a signal source impedance (“Z_{source}”) 1704 and a load having a load impedance (“Z_{load}”) 1706 via signal paths 1708 and 1710, respectively. Port 1742 may be an output port whose output is proportional to reflected voltage signal V_{reflected} 1734, and port 1744 may be an output port whose output is proportional to incident voltage signal V_{incident} 1732.

In general, the integrated low-loss directional bridge 1700 is an implementation that is a lower-insertion loss alternative to an implementation formed by cascading two single-directional bridges having a low-pass configuration as described in FIGS. 4 and 7. This lower-insertion loss alternative is feasible if the differential input impedances of the differential amplifiers 1722 and 1736 are high and the impedance of the series combinations of resistor R₂ 1714 and capacitor C₃ 1716 and of resistor R₂ 1738 and capacitor C₃ 1740 is high compared to characteristic impedance Z₀.

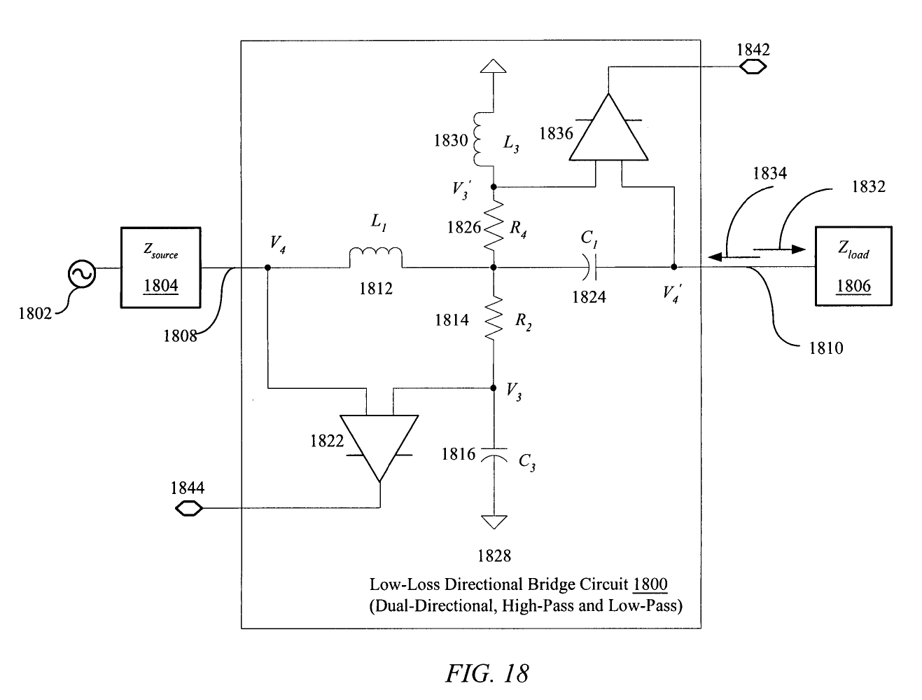

FIG. 18 shows a block diagram of yet another example of an implementation of a low-loss directional bridge circuit 1800 utilizing a cascaded dual-directional bridge topology with two differential amplifiers 1822 and 1836 in accordance with the invention. The low-loss directional bridge circuit 1800 may be in signal communication with a signal source 1802 having a signal source impedance (“Z_{source}”) 1804 and a load having a load impedance (“Z_{load}”) 1806 via signal paths 1808 and 1810, respectively. Port 1842 may be an output port whose output is proportional to reflected voltage signal V_{reflected} 1834, and port 1844 may be an output port whose output is proportional to incident voltage signal V_{incident} 1832.

In general, the integrated low-loss directional bridge 1800 is an implementation that is similar to the implementation shown in FIG. 17 with the exception that it is formed by cascading two single-directional bridges, with one having a low-pass configuration and the other a high-pass configuration. As in the implementation shown in FIG. 17, this implementation also requires that the differential input impedances of the differential amplifiers 1822 and 1836 are high and the impedance of the series combination of resistor R₂ 1814 and capacitor C₃ 1816 and of resistor R₄ 1826 and inductor L₃ 1830 are high compared to characteristic impedance Z₀.

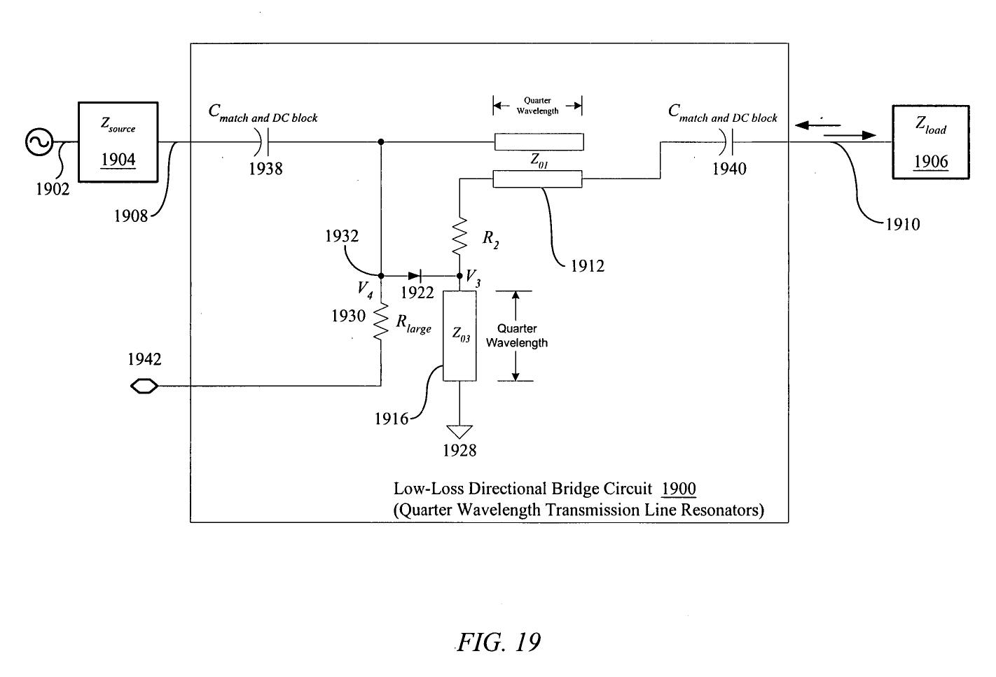

In FIG. 19, a block diagram of an example of an implementation of a low-loss directional bridge circuit 1900 utilizing a directional circuit topology that includes a detector diode 1922, and two quarter wavelength transmission line resonators 1912 and 1916, is shown in accordance with the invention. The low-loss directional bridge circuit 1900 may be in signal communication with a signal source 1902 having a signal source impedance (“Z_{source}”) 1904 and a load having a load impedance (“Z_{load}”) 1906 via signal paths 1908 and 1910, respectively. C_{match and DC block} 1938 and 1940 are matching capacitor elements and they may also function as DC blocks that are useful for preventing a DC voltage at signal paths 1908 or 1910, respectively, from appearing at the detector output port 1942. Port 1942 may be a negative detector output. The low-loss directional bridge circuit 1900 may operate near resonance for low insertion loss, where Z₀=(Z₀₁)(Z₀₃)/R₂. Z₀₁ is the characteristic impedance of the series transmission line resonator 1912 and Z₀₃ is the characteristic impedance of the shunt transmission line resonator 1916. R_{large} 1930 may be large enough so that there is negligible current flowing from node 1932 to port 1942 and the insertion loss from signal path 1908 to signal path 1910 is not increased.

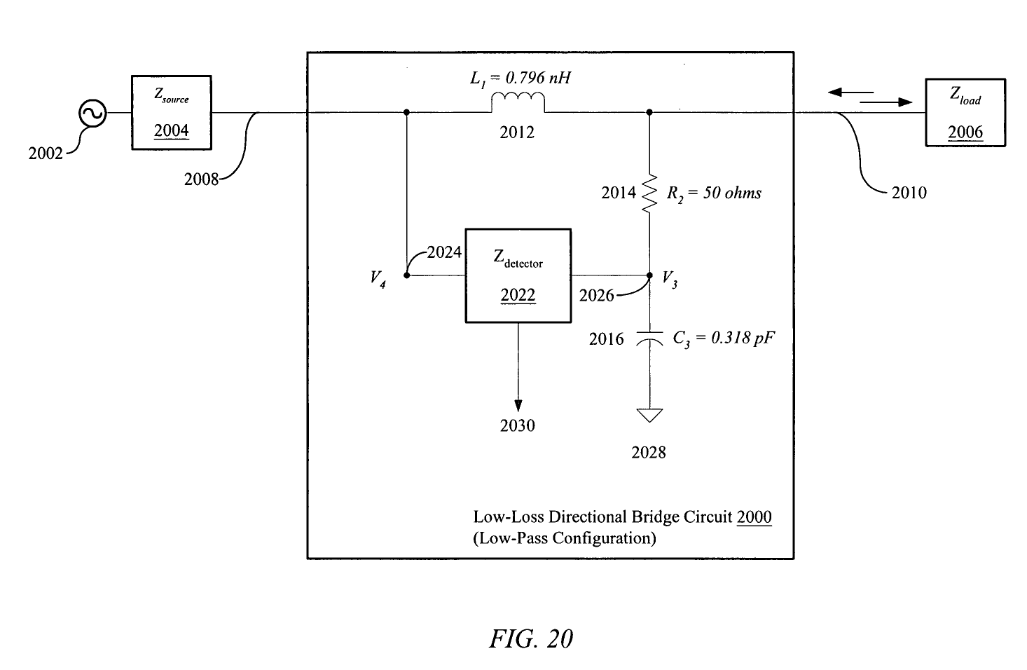

FIGS. 20, 21, and 22 show block diagrams of example implementations of low-loss directional bridge circuits 2000, 2100, and 2200, respectively, each with a coupling factor of −14 dB at 1 GHz and varying insertion gains. In FIG. 20, a block diagram of an example of an implementation of a low-loss directional bridge circuit 2000 in a low-pass configuration that includes a series inductor 2012, a shunt resistor 2014, and a shunt capacitor 2016, is shown in accordance with the invention. In a specific implementation, inductor L₁ 2012=0.796 nH, resistor R₂ 2014=50 ohms, and capacitor C₃ 2016=0.318 pF. At a frequency of 1 GHz, the coupling factor is equal to −14 dB, with an insertion gain equal to −0.043 dB.

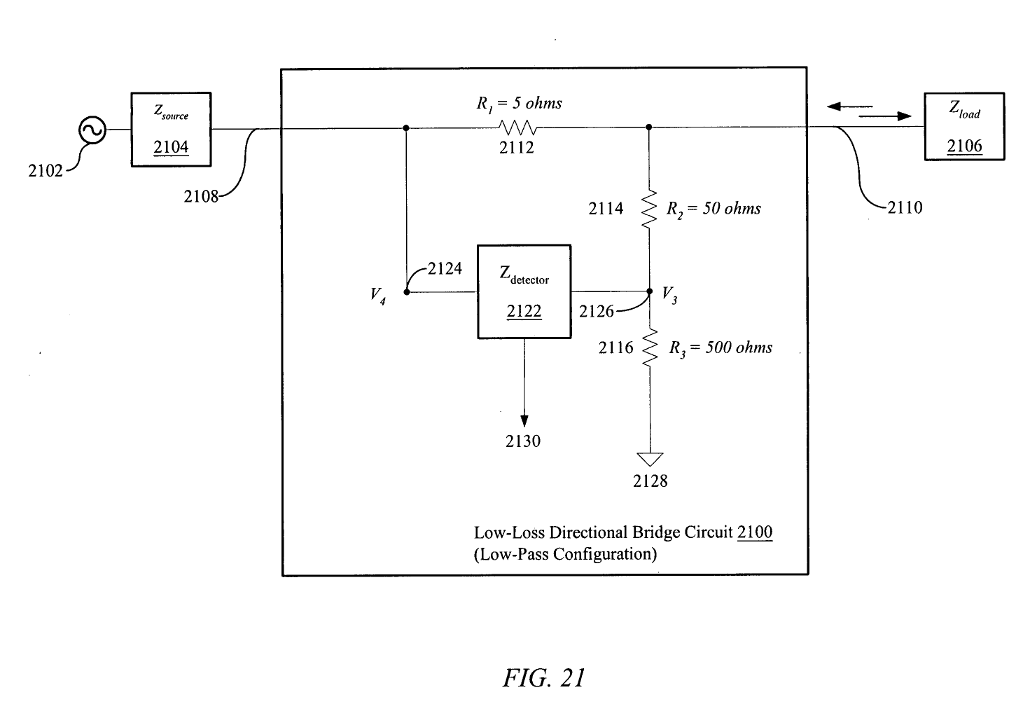

In FIG. 21, a block diagram of an example of an implementation of the low-loss directional bridge circuit 2100 is shown in accordance with the invention. This low-loss directional bridge circuit 2100 is similar to that configuration shown in FIG. 3 and is implemented entirely with resistors. In a specific implementation, resistor R₁ 2112=5 ohms, resistor R₂ 2114=50 ohms, and resistor R₃ 2116=500 ohms. At a broadband frequency, the coupling factor is equal to −14 dB, with an insertion gain equal to −0.82 dB.

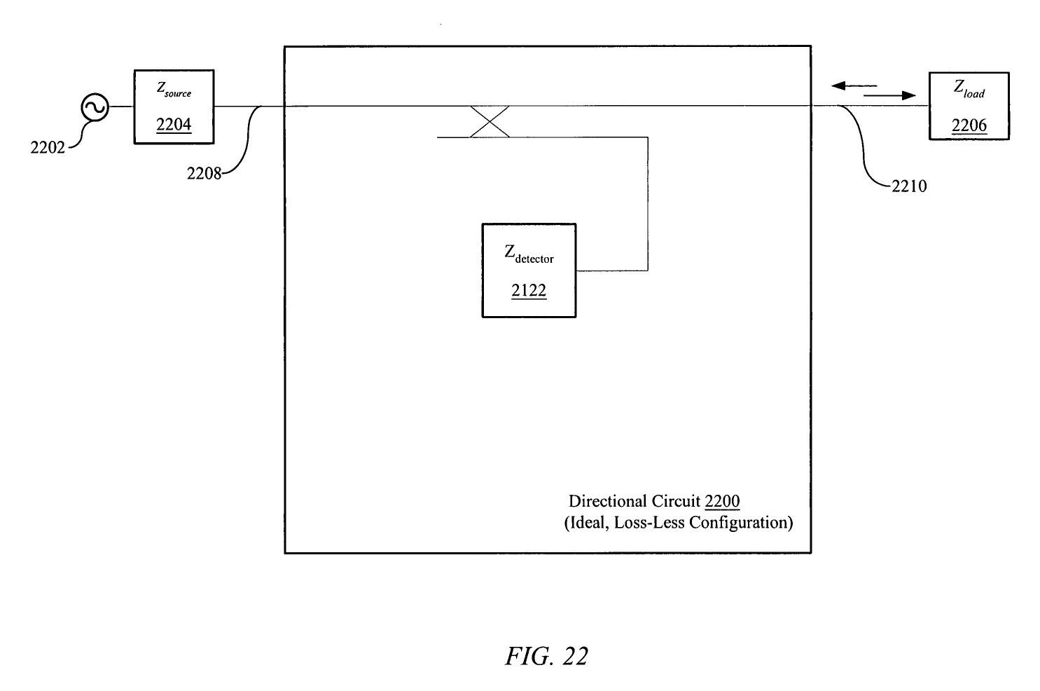

In FIG. 22, a block diagram of an example of an implementation of the ideal lossless directional coupler circuit 2200 with perfect match to characteristic impedance Z₀ is shown for purposes of comparison with low-loss directional bridge circuit in accordance with the invention. At a broadband frequency, the coupling factor is equal to −14 dB, with an insertion gain equal to −0.18 dB. For the ideal loss-less directional bridge circuit 2200, the through-line gain is given by the following equation:

$$Through\_line {\_gain}_{Ideal\_coupler} = \frac{1}{1 + {C}^{2}} , where C is the coupling \text{-} factor as a voltage ratio . \qquad ( 14 )$$

As illustrated by FIGS. 20, 21, and 22, a low-loss directional bridge circuit with reactive elements in accordance with the invention may have lower insertion loss than an ideal directional coupler circuit whenever the detector element has a high impedance. If, however, the impedance of the detector element were Z₀, the ideal directional coupler circuit would have a lower insertion loss for the same coupling factor.

As noted in the detailed description of FIG. 10 above, the coupling factor of directional bridge circuits having a low-pass or a high-pass configuration may vary with frequency. In the low-pass configuration, the coupling factor increases as the frequency increases, and in the high-pass configuration, the coupling factor decreases as the frequency increases. FIG. 10 shows a block diagram of an example of an implementation of an integrated low-loss directional bridge circuit 1000 that compensates for this frequency variation by utilizing a compensating filter in the detection circuitry. Another method for compensating for coupling frequency variation is to cascade a low-loss directional bridge in a low-pass configuration with a low-loss directional bridge in a high-pass configuration and then to sum the detector outputs of both circuits.

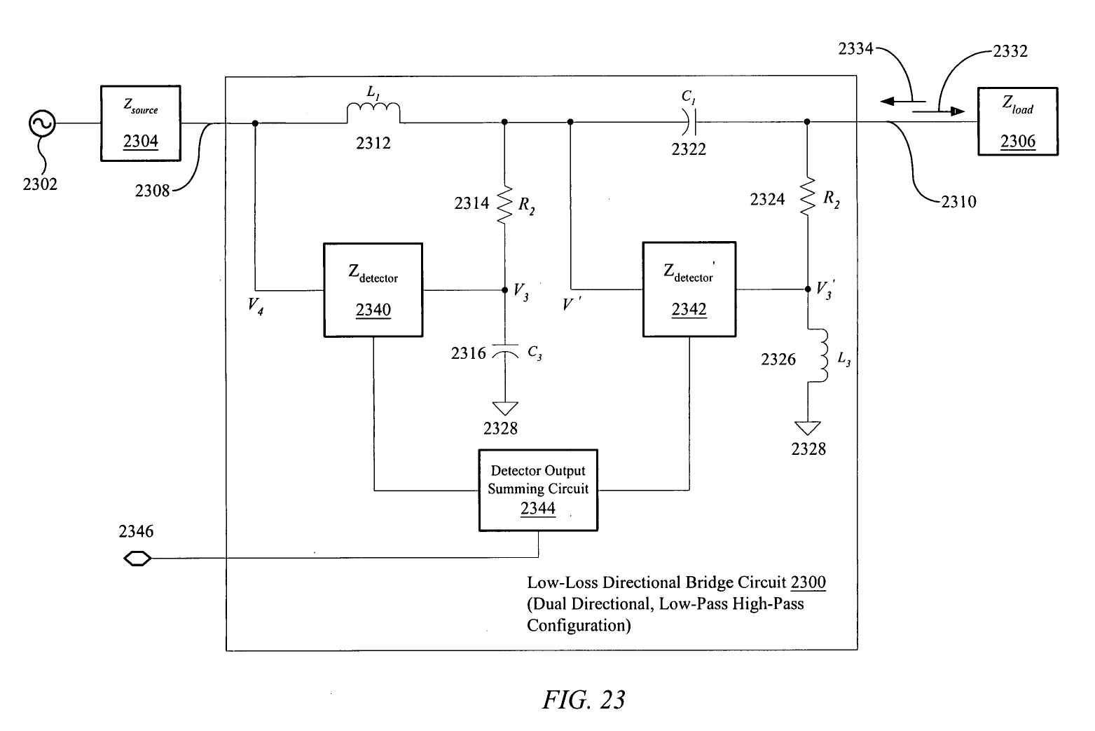

In FIG. 23, a block diagram of an example of an implementation of a low-loss directional bridge circuit 2300 utilizing a dual-directional bridge topology formed by cascading two single-directional bridges, with one having a low-pass configuration and the other a high-pass configuration, is shown in accordance with the invention. The low-loss directional bridge circuit 2300 may be in signal communication with a signal source 2302 having a signal source impedance (“Z_{source}”) 2304 and a load having a load impedance (“Z_{load}”) 2306 via signal paths 2308 and 2310, respectively. Z_{detector} 2340 is a sensing element whose output is proportional to the incident voltage signal V_{incident} 2332, and Z_{detector} 2342 is a sensing element whose output is also proportional to incident voltage signal V_{incident} 2332. The outputs of Z_{detector} 2340 and Z_{detector} 2342 are input to and summed in Detector Output Summing Circuit 2344. Port 2346 is the output of Detector Output Summing Circuit 2344.

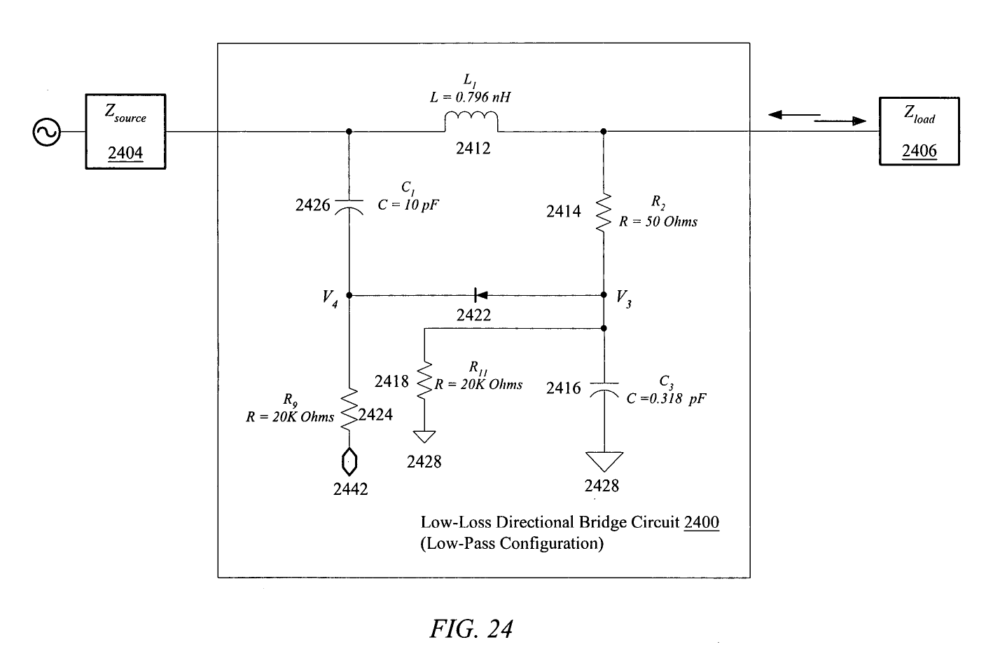

The method of summing outputs in a dual-directional bridge circuit may depend on the nature of the detection circuitry of the bridge circuits. FIGS. 24, 25, and 26 show block diagrams of various examples of implementations of low-loss directional bridge circuits without frequency compensation and with frequency compensation, with lumped elements given specific example values.

In FIG. 24, a block diagram of an example of an implementation of an integrated low-loss directional bridge circuit 2400 utilizing a directional circuit topology in a low-pass configuration that includes a series inductor L₁ 2412, a shunt resistor R₂ 2414, and a shunt capacitor C₃ 2416 and that utilizes a detector diode 2422, is shown in accordance with the invention. Port 2442 is a positive detector output that is not frequency compensated.

Illustrative values (for an operating frequency of 1 GHz) are as follows: inductor L₁ 2412=0.796 nH; resistor R₂ 2414=50 Ohms; and capacitor C₃ 2416=0.318 pF. Resistors R₉ 2424 and R₁₁ 2418 are set to 20K Ohms. Note that resistors R₉ 2424 and R₁₁ 2418 are the equivalents of resistors R_{large} 1018 and 1038, FIG. 10. It is appreciated that resistors R₉ 2424 and R₁₁ 2418 may have values that are large enough so as to minimize the insertion loss and that the actual values chosen are not critical. Capacitor C₁ 2426 is set to 10 pF. Note that capacitor C₁ 2426 is the equivalent of capacitor C_{large} 1036, FIG. 10. It is appreciated that capacitor C₁ 2426 may have a low impedance at the operating frequency and that the actual value chosen is not critical. In general, for a fixed R₂, the ratio of L₁/C₃ may be kept constant; and L₁ and C₃ may be increased for a higher coupling factor and increased insertion loss.

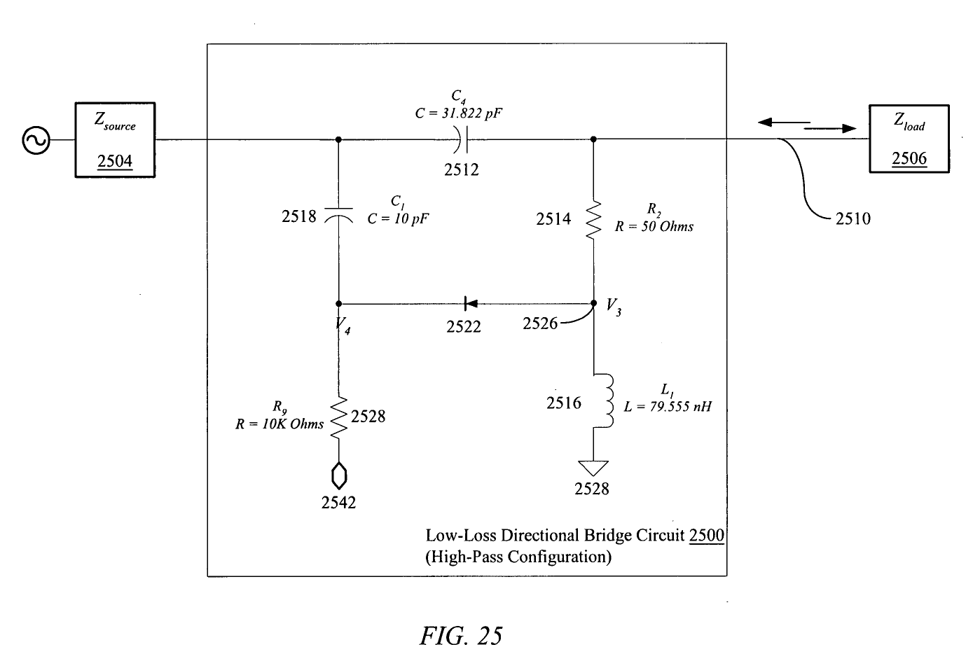

In FIG. 25, a block diagram of an example of an implementation of an integrated low-loss directional bridge circuit 2500 utilizing a directional circuit topology in a high-pass configuration that includes a series capacitor C₄ 2512, a shunt resistor R₂ 2514, and a shunt inductor L₁ 2516 and that utilizes a detector diode 2522, is shown in accordance with the invention. Port 2542 is a positive detector output that is not frequency compensated.

Illustrative values (for an operating frequency of 1 GHz) are as follows: capacitor C₄ 2512=31.833 pF; resistor R₂ 2514=50 Ohms; and inductor L₁ 2516=79.555 nH. Resistor R₉ 2528 is set to 10K Ohms. Note that resistor R₉ 2528 is the equivalent of resistors R_{large} 1236, FIG. 12. It is appreciated that resistor R₉ 2524 may have values that are large enough so as to minimize the insertion loss and that the actual value chosen is not critical. Capacitor C₁ 2518 is set to 10 pF. Note that capacitor C₁ 2518 is the equivalent of capacitor C_{large} 1136, FIG. 11. It is appreciated that capacitor C₁ 2518 may have a low impedance at the operating frequency and that the actual value chosen is not critical. In general, for a fixed R₂, the ratio of L₁/C₃ may be kept constant; and L1 and C3 may be decreased for a higher coupling factor and increased insertion loss.

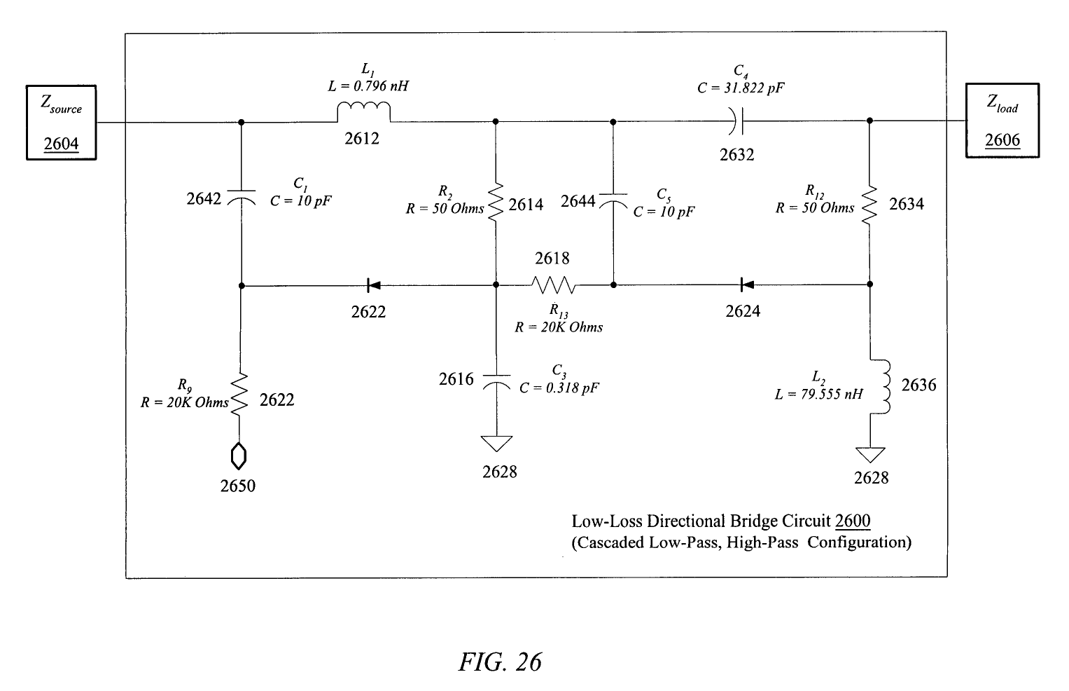

In FIG. 26, a block diagram of an example of an implementation of an integrated low-loss directional bridge circuit 2600 utilizing a directional circuit topology formed by cascading two single-directional bridges, with one having a low-pass configuration and the other a high-pass configuration, is shown in accordance with the invention. Low-loss directional bridge circuit 2600 includes a series inductor L₁ 2612, a shunt resistor R₂ 2614, a shunt capacitor C₃ 2616, a series capacitor C₄ 2632, a shunt resistor R₁₂ 2634, a shunt inductor L₂ 2636, detector diodes 2622 and 2624, resistors R₉ 2622 and R₁₃ 2618, and capacitors C₁ 2642 and C₅ 2644. Port 2650 is the positive detector output that is frequency compensated.

Illustrative values (for an operating frequency of 1 GHz) are as follows: inductor L₁ 2612=0.796 nH; resistor R₂ 2614=50 Ohms; capacitor C₃ 2616=0.318 pF; capacitor C₄ 2632=31.822 pF; resistor R₁₂ 2634=50 Ohms; and inductor L₂ 2636=79.555 nH. Resistors R₉ 2622 and R₁₃ 2618 are set to 20K Ohms. Note that resistors R₉ 2622 and R₁₃ 2618 are the equivalents of resistors R_{large} 1018 and 1038, FIG. 10. It is appreciated that resistors R₉ 2622 and R₁₃ 2618 may have values that are large enough so as to minimize the insertion loss and that the actual values chosen are not critical. Capacitors C₁ 2642 and C₅ 2644 are set to 10 pF. Note that capacitors C₁ 2642 and C₅ 2644 are the equivalent of capacitor C_{large} 1036, FIG. 10. It is appreciated that capacitors C₁ 2642 and C₅ 2644 may have a low impedance at the operating frequency and that the actual value chosen is not critical.

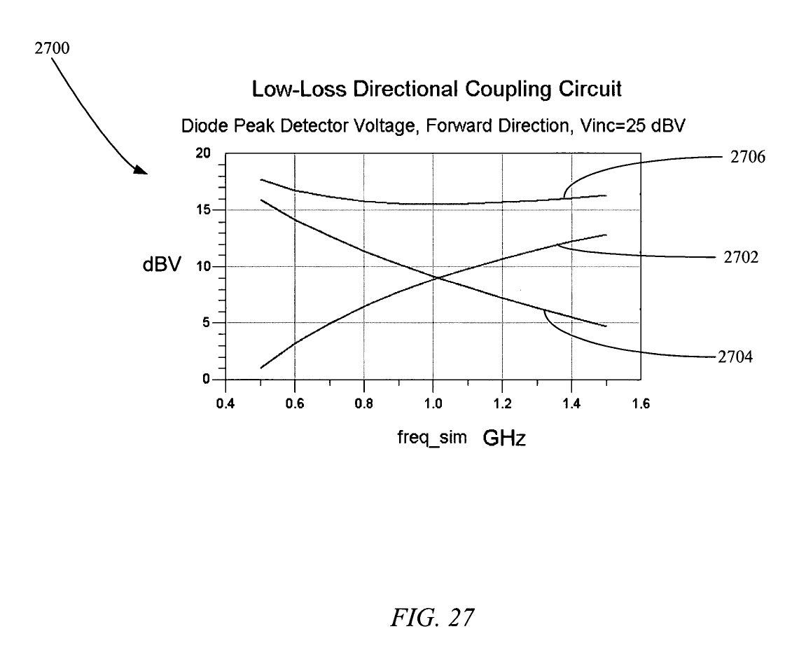

FIG. 27 shows a graphical representation of a plot of detector output in decibels (“dBV”) versus frequency in gigahertz (“GHz”) for the examples of implementations of integrated low-loss directional bridge circuits shown in FIGS. 24, 25, and 26. Line 2702 shows the plot for the low-loss directional bridge circuit 2400 having a low-pass configuration shown in FIG. 24; line 2704 shows the plot for the low-loss directional bridge circuit 2500 having a high-pass configuration shown in FIG. 25; and Line 2706 shows the plot for the low-loss directional bridge circuit 2600 having a cascaded low-pass and high-pass bridge configuration shown in FIG. 26.

In general, the graphical representation of FIG. 27 shows that as the frequency increases in a low-pass low-loss directional bridge circuit, the coupling factor increases (plot 2702), and that as the frequency increases in a high-pass low-loss directional bridge circuit, the coupling factor decreases (plot 2704). By utilizing a directional circuit topology formed by cascading a high-pass directional bridge and a low-pass directional bridge, as shown in FIG. 26, a bridge circuit is produced that has a flatter frequency response and a higher coupling factor at the operating frequency, as shown by plot 2706.

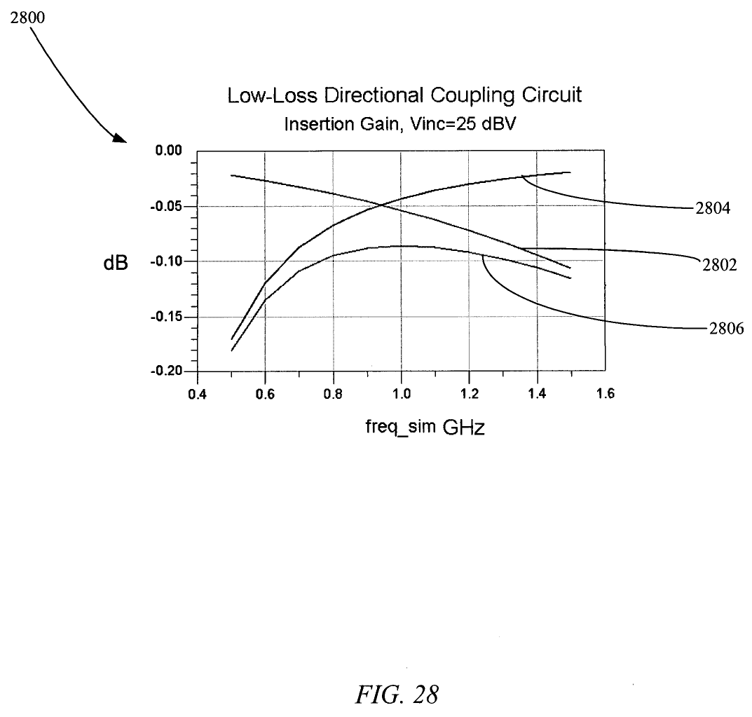

FIG. 28 shows a graphical representation of a plot of insertion gain in dB versus frequency in GHz for the examples of implementations of integrated low-loss directional bridge circuits shown in FIGS. 24, 25, and 26. Line 2802 shows the plot for the low-loss directional bridge circuit 2400 having a low-pass configuration shown in FIG. 24; line 2804 shows the plot for the low-loss directional bridge circuit 2500 having a high-pass configuration shown in FIG. 25; and Line 2806 shows the plot for the low-loss directional bridge circuit 2600 consisting of cascaded low-pass and high-pass low-loss directional bridges shown in FIG. 26.

In general, the graphical representation of FIG. 28 shows that as the frequency increases in a low-pass low-loss directional bridge circuit, the insertion gain decreases (plot 2802), and that as the frequency increases in a high-pass low-loss directional bridge circuit, the insertion gain increases (plot 2804). Plot 2806 shows that a cascaded low-pass high-pass directional bridge circuit, as shown in FIG. 26, has a lower insertion gain throughout its frequency range

While the foregoing description refers to the use of an integrated directional low-loss bridge, the subject matter is not limited to such a system. Any directional bridge system that could benefit from the functionality provided by the components described above may be implemented in the example implementation of Low-Loss Directional Bridge 300.

Moreover, it will be understood that the foregoing description of numerous implementations has been presented for purposes of illustration and description. It is not exhaustive and does not limit the claimed inventions to the precise forms disclosed. Modifications and variations are possible in light of the above description or may be acquired from practicing the invention. The claims and their equivalents define the scope of the invention.

What is claimed:

1. A low-loss directional bridge for measuring propagated signals from a source device to a load device and from the load device to the source device, where both the source device and load device are in signal communication with the low-loss directional bridge, the low-loss directional bridge comprising:
a first bridge circuit network; and
a first sensing element in signal communication with the first bridge circuit network, wherein the first sensing element produces a first measured signal that is proportional to the propagated signals.

2. The directional bridge of claim 1,
wherein the first bridge circuit network includes
a first impedance element in signal communication with both the source device and the first sensing element at a first node,
a second impedance element in signal communication with the first impedance element at a second node and in signal communication with the first sensing element at a third node, and
a third impedance element in signal communication with both the second impedance element and the first sensing element at the third node,
wherein the first measured signal is produced by the first sensing element in response to detecting a difference in voltage between a first voltage at the first node and a second voltage at the third node.

3. The directional bridge of claim 2, wherein the first measured signal is proportional to the propagated signal from the source device to the load device or to the propagated signal from the load device to the source device.

4. The directional bridge of claim 3, wherein the first sensing element is selected from the group consisting of transformer, diode, power sensing device, voltage sensing device, balun, differential amplifier, mixer, and sampler.

5. The directional bridge of claim 4, wherein the third impedance element is in signal communication with a common ground.

6. The directional bridge of claim 4, wherein both the first impedance element and the second impedance element are in signal communication with the load device at the second node.

7. The directional bridge of claim 4, wherein the first impedance element, the second impedance element, and the third impedance element are all lumped two-terminal elements.

8. The directional bridge of claim 7, wherein the first bridge circuit network has a low-pass configuration wherein the first impedance element includes an inductor, the second impedance element includes a shunt resistor, and the third impedance element includes a shunt capacitor.

9. The directional bridge of claim 8, further including a resistor in series with the first impedance.

10. The directional bridge of claim 8, further including:
a fourth impedance element that includes a shunt resistor, in signal communication with the source device, the first impedance, and the first sensing element at the first node,
a fifth impedance element that includes a shunt capacitor, in signal communication with the fourth impedance element at the first second node and in signal communication with the first sensing element at a third node, and
a second sensing element in signal communication with both the fourth impedance element and the fifth impedance element at the fourth node and in signal communication with the first impedance element, the second impedance element, and the load device at the second node, wherein the second sensing element produces a second measured signal that is proportional to the propagated signals.

11. The directional bridge of claim 10, wherein the first measured signal and the second measured signal are summed in a detector output summing circuit.

12. The directional bridge of claim 8, further including:
a second bridge circuit network, the second bridge circuit network having a high-pass configuration including:
a fourth impedance element that includes a capacitor, in signal communication with both the source device and the first sensing element at a first node,
a fifth impedance element that includes a shunt resistor, in signal communication with the first impedance element at a second node and in signal communication with the first sensing element at a third node, and
a third impedance element that includes a shunt inductor, in signal communication with both the second impedance element and the first sensing element at the third node,
wherein the first measured signal is produced by the first sensing element in response to detecting a difference in voltage between a first voltage at the first node and a second voltage at the third node.

13. The directional bridge of claim 8, further including a plurality of series matching elements, with at least one matching element in signal communication with the source device and at least one other matching element in signal communication with the load device.

14. The directional bridge of claim 13, wherein the series matching elements are capacitors.

15. The directional bridge of claim 7, wherein the first bridge circuit network has a high-pass configuration wherein the first impedance element includes a capacitor, the second impedance element includes a shunt resistor, and the third impedance element includes a shunt inductor.

16. The directional bridge of claim 15, further including:
a second bridge circuit network, the second bridge circuit network having a low-pass configuration including:
a fourth impedance element that includes an inductor, in signal communication with both the first impedance and the second impedance at the second node and in signal communication with load device at a fourth node;
a fifth impedance element that includes a shunt resistor, in signal communication with the first impedance element, the second impedance element, and the fourth impedance element at the second node;
a sixth impedance element that includes a shunt capacitor, in signal communication with the fifth impedance element at a fifth node; and
a second sensing element in signal communication with the both the fifth impedance and the sixth impedance at the fourth node and in signal communication with load device at the third node,
wherein a second measured signal is produced by the second sensing element in response to detecting a difference in voltage between a first voltage at the fourth node and a second voltage at the fifth node.

17. The directional bridge of claim 16, wherein the first measured signal and the second measured signal are summed in a detector output summing circuit.

18. The directional bridge of claim 16, wherein the first sensing element and the second sensing element are detector diodes.

19. The directional bridge of claim 16, wherein the first sensing element and the second sensing element each further include a low-pass filter that includes a compensating resistor and a compensating capacitor.

20. The directional bridge of claim 15, further including a plurality of series matching elements, with at least one matching element in signal communication with the source device and at least one other matching element in signal communication with the load device.

21. The directional bridge of claim 20, wherein the series matching elements are either capacitors or inductors.

22. The directional bridge of claim 7, wherein the first bridge circuit network has a bandpass configuration wherein the first impedance element includes a series resonator, the second impedance element includes a shunt resistor, and the third impedance element includes a parallel resonator.

23. The directional bridge of claim 22, wherein the series resonator includes a capacitor and an inductor, and the parallel resonator includes a capacitor and an inductor.

24. The directional bridge of claim 22, wherein the series and parallel resonators are transmission line resonators.

25. The directional bridge of claim 4 wherein the first sensing element includes a frequency compensation network.
